(19) United States
(12) Patent Application Publication
(10) Pub. No.: US 2023/0246701 A1
(43) Pub. Date: Aug. 3, 2023

(54) BANDWIDTH PART (BWP) DESIGN IN LAYER-2 (L2) SIDELINK RELAY SYSTEMS

(71) Applicant: QUALCOMM Incorporated, San Diego, CA (US)

(72) Inventors: Peng CHENG, Beijing (CN); Qing LI, Princeton Junction, NJ (US); Ozcan OZTURK, San Diego, CA (US); Karthika PALADUGU, San Diego, CA (US); Gavin Bernard HORN, La Jolla, CA (US); Hong CHENG, Basking Ridge, NJ (US); Dan VASSILOVSKI, Del Mar, CA (US)

(21) Appl. No.: 18/000,266

(22) PCT Filed: Jul. 9, 2021
(86) PCT No.: PCT/CN2021/105397

§ 371 Date: Nov. 29, 2022

(30) Foreign Application Priority Data
Jul. 24, 2020 (WO) PCT/CN2020/104511

(51) Int. Cl. H04B 7/155; H04W 68/00; H04W 76/14; H04W 72/25; H04W 72/0457; H04W 76/27

(52) U.S. Cl. CPC H04B 7/15528; H04W 68/005; H04W 76/14; H04W 72/25; H04W 72/0457; H04W 76/27

(57) ABSTRACT

Disclosed are techniques for wireless communication. In an aspect, a relay user equipment (UE) establishes a sidelink with a remote UE to provide one or more UE-to-network relay services to the remote UE, monitors paging occasions (POs) in a first bandwidth part (BWP), receives a page from a serving base station during a PO in the first BWP, and forwards the page to the remote UE over the sidelink in an initial sidelink BWP. In another aspect, the relay UE receives downlink control information (DCI) from a serving base station for a downlink grant for the remote UE, receives downlink data for the remote UE from the serving base station, transmits sidelink control information (SCI) instructing the remote UE to switch from a first sidelink BWP to a second sidelink BWP, and forwards the downlink data to the remote UE over the second sidelink BWP of the sidelink.

### CROSS-REFERENCE TO RELATED APPLICATIONS

The present Application for Patent claims priority under 35 U.S.C. § 119 to International Patent Application No. PCT/CN2020/104511, entitled “BANDWIDTH PART (BWP) DESIGN IN L2 SIDELINK RELAY SYSTEMS,” filed Jul. 24, 2020, and to International Patent Application No. PCT/CN2021/105397, entitled “BANDWIDTH PART (BWP) DESIGN IN LAYER-2 (L2) SIDELINK RELAY SYSTEMS,” filed Jul. 9, 2021, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a relay user equipment (UE) includes establishing a sidelink with a remote UE to provide one or more UE-to-network relay services to the remote UE; monitoring paging occasions (POs) in a first bandwidth part (BWP); receiving a first page from a serving base station during a PO in the first BWP; and forwarding the first page to the remote UE over the sidelink in an initial sidelink BWP for the sidelink.

In an aspect, a method of wireless communication performed by a remote user equipment (UE) includes establishing a sidelink with a relay UE to receive one or more UE-to-network relay services from the relay UE; and receiving, from the relay UE over the sidelink in an initial sidelink BWP for the sidelink, a first page forwarded from a serving base station, wherein the first page was transmitted by the serving base station in a first bandwidth part (BWP).

In an aspect, a method of wireless communication performed by a relay user equipment (UE) includes establishing a sidelink with a remote UE to provide one or more UE-to-network relay services to the remote UE; receiving downlink control information (DCI) from a serving base station for a downlink grant for the remote UE; receiving downlink data for the remote UE from the serving base station; transmitting sidelink control information (SCI) instructing the remote UE to switch from a first sidelink bandwidth part (BWP) of the sidelink to a second sidelink BWP of the sidelink; and forwarding the downlink data to the remote UE over the second sidelink BWP of the sidelink.

In an aspect, a method of wireless communication performed by a remote user equipment (UE) includes establishing a sidelink with a relay UE to receive one or more UE-to-network relay services from the relay UE; receiving sidelink control information (SCI) instructing the remote UE to switch from a first sidelink bandwidth part (BWP) of the sidelink to a second sidelink BWP of the sidelink; and receiving downlink data from a serving base station via the relay UE over the second sidelink BWP of the sidelink.

In an aspect, a relay user equipment (UE) includes a memory; at least one transceiver; and at least one processor communicatively coupled to the memory and the at least one transceiver, the at least one processor configured to: establish a sidelink with a remote UE to provide one or more UE-to-network relay services to the remote UE; monitor paging occasions (POs) in a first bandwidth part (BWP); receive, via the at least one transceiver, a first page from a serving base station during a PO in the first BWP; and forward the first page to the remote UE over the sidelink in an initial sidelink BWP for the sidelink.

In an aspect, a remote user equipment (UE) includes a memory; at least one transceiver; and at least one processor communicatively coupled to the memory and the at least one transceiver, the at least one processor configured to: establish a sidelink with a relay UE to receive one or more UE-to-network relay services from the relay UE; and receive, via the at least one transceiver, from the relay UE over the sidelink in an initial sidelink BWP for the sidelink, a first page forwarded from a serving base station, wherein the first page was transmitted by the serving base station in a first bandwidth part (BWP).

In an aspect, a relay user equipment (UE) includes a memory; at least one transceiver; and at least one processor communicatively coupled to the memory and the at least one transceiver, the at least one processor configured to: establish a sidelink with a remote UE to provide one or more UE-to-network relay services to the remote UE; receive, via the at least one transceiver, downlink control information (DCI) from a serving base station for a downlink grant for the remote UE; receive, via the at least one transceiver, downlink data for the remote UE from the serving base station; transmit, via the at least one transceiver, sidelink control information (SCI) instructing the remote UE to switch from a first sidelink bandwidth part (BWP) of the sidelink to a second sidelink BWP of the sidelink; and forward the downlink data to the remote UE over the second sidelink BWP of the sidelink.

In an aspect, a remote user equipment (UE) includes a memory; at least one transceiver; and at least one processor communicatively coupled to the memory and the at least one transceiver, the at least one processor configured to: establish a sidelink with a relay UE to receive one or more UE-to-network relay services from the relay UE; receive, via the at least one transceiver, sidelink control information (SCI) instructing the remote UE to switch from a first sidelink bandwidth part (BWP) of the sidelink to a second sidelink BWP of the sidelink; and receive, via the at least one transceiver, downlink data from a serving base station via the relay UE over the second sidelink BWP of the sidelink.

In an aspect, a relay user equipment (UE) includes means for establishing a sidelink with a remote UE to provide one or more UE-to-network relay services to the remote UE; means for monitoring paging occasions (POs) in a first bandwidth part (BWP); means for receiving a first page from a serving base station during a PO in the first BWP; and means for forwarding the first page to the remote UE over the sidelink in an initial sidelink BWP for the sidelink.

In an aspect, a remote user equipment (UE) includes means for establishing a sidelink with a relay UE to receive one or more UE-to-network relay services from the relay UE; and means for receiving, from the relay UE over the sidelink in an initial sidelink BWP for the sidelink, a first page forwarded from a serving base station, wherein the first page was transmitted by the serving base station in a first bandwidth part (BWP).

In an aspect, a relay user equipment (UE) includes means for establishing a sidelink with a remote UE to provide one or more UE-to-network relay services to the remote UE; means for receiving downlink control information (DCI) from a serving base station for a downlink grant for the remote UE; means for receiving downlink data for the remote UE from the serving base station; means for transmitting sidelink control information (SCI) instructing the remote UE to switch from a first sidelink bandwidth part (BWP) of the sidelink to a second sidelink BWP of the sidelink; and means for forwarding the downlink data to the remote UE over the second sidelink BWP of the sidelink.

In an aspect, a remote user equipment (UE) includes means for establishing a sidelink with a relay UE to receive one or more UE-to-network relay services from the relay UE; means for receiving sidelink control information (SCI) instructing the remote UE to switch from a first sidelink bandwidth part (BWP) of the sidelink to a second sidelink BWP of the sidelink; and means for receiving downlink data from a serving base station via the relay UE over the second sidelink BWP of the sidelink.

In an aspect, a non-transitory computer-readable medium stores computer-executable instructions that, when executed by a relay user equipment (UE), cause the relay UE to: establish a sidelink with a remote UE to provide one or more UE-to-network relay services to the remote UE; monitor paging occasions (POs) in a first bandwidth part (BWP); receive a first page from a serving base station during a PO in the first BWP; and forward the first page to the remote UE over the sidelink in an initial sidelink BWP for the sidelink.

In an aspect, a non-transitory computer-readable medium stores computer-executable instructions that, when executed by a remote user equipment (UE), cause the remote UE to: establish a sidelink with a relay UE to receive one or more UE-to-network relay services from the relay UE; and receive, from the relay UE over the sidelink in an initial sidelink BWP for the sidelink, a first page forwarded from a serving base station, wherein the first page was transmitted by the serving base station in a first bandwidth part (BWP).

In an aspect, a non-transitory computer-readable medium stores computer-executable instructions that, when executed by a relay user equipment (UE), cause the relay UE to: establish a sidelink with a remote UE to provide one or more UE-to-network relay services to the remote UE; receive downlink control information (DCI) from a serving base station for a downlink grant for the remote UE; receive downlink data for the remote UE from the serving base station; transmit sidelink control information (SCI) instructing the remote UE to switch from a first sidelink bandwidth part (BWP) of the sidelink to a second sidelink BWP of the sidelink; and forward the downlink data to the remote UE over the second sidelink BWP of the sidelink.

In an aspect, a non-transitory computer-readable medium stores computer-executable instructions that, when executed by a remote user equipment (UE), cause the remote UE to: establish a sidelink with a relay UE to receive one or more UE-to-network relay services from the relay UE; receive sidelink control information (SCI) instructing the remote UE to switch from a first sidelink bandwidth part (BWP) of the sidelink to a second sidelink BWP of the sidelink; and receive downlink data from a serving base station via the relay UE over the second sidelink BWP of the sidelink.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B illustrate user plane and control plane protocol stacks, according to aspects of the disclosure.

FIG. 5 illustrates the different radio resource control (RRC) states available in New Radio (NR), according to aspects of the disclosure.

FIG. 6A is a diagram illustrating an example frame structure, according to aspects of the disclosure.

FIG. 6B is a diagram illustrating various downlink channels within an example downlink slot, according to aspects of the disclosure.

FIGS. 7A and 7B illustrate example call flows for different types of proximity services (ProSe) Direct Discovery.

FIG. 8 is a diagram of a simplified Layer-2 frame format for ProSe Direct Discovery messages.

FIG. 9A illustrates an example call flow showing Layer-3 procedures for UE-to-network relay establishment.

FIG. 9B illustrates an example call flow showing Layer-2 procedures for UE-to-network relay establishment.

FIGS. 10A to 10C are diagrams of different paging scenarios.

FIGS. 11 to 15 illustrate example call flows for different forward paging scenarios.

FIGS. 16 to 19 illustrate example methods of wireless environment sensing, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

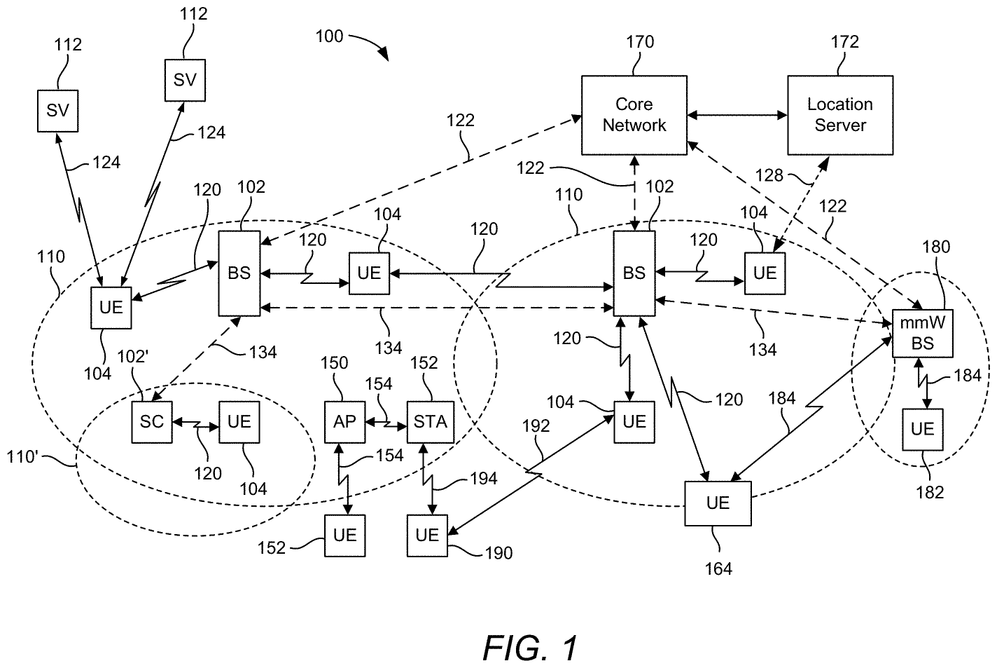

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more S Cells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

Sidelink communication may be used for D2D media-sharing, vehicle-to-vehicle (V2V) communication, V2X communication (e.g., cellular V2X (cV2X) communication, enhanced V2X (eV2X) communication, etc.), emergency rescue applications, etc. One or more of a group of UEs utilizing D2D communications may be within the geographic coverage area 110 of a base station 102. Other UEs in such a group may be outside the geographic coverage area 110 of a base station 102 (as illustrated by UE 190) or be otherwise unable to receive transmissions from a base station 102. In some cases, groups of UEs communicating via D2D communications may utilize a one-to-many (1:M) system in which each UE transmits to every other UE in the group. In some cases, a base station 102 facilitates the scheduling of resources for D2D communications. In other cases, D2D communications are carried out between UEs without the involvement of a base station 102.

In an aspect, the sidelinks 192 and 194 may operate over a communication medium of interest, which may be shared with other communications between other vehicles and/or infrastructure access points, as well as other RATs. A “medium” may be composed of one or more frequency, time, and/or space communication resources (e.g., encompassing one or more channels across one or more carriers) associated with communication between one or more transmitter/receiver pairs.

In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by WLAN technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates three of the UEs connected over sidelinks (i.e., WLAN STA 152, UE 190, one UE 104), any of the illustrated UEs may engage in sidelink communication. In addition, although only UE 182 was described as being capable of beam forming, any of the illustrated UEs may be capable of beam forming. For example, where UE 190 is capable of beam forming, it may beam form over the sidelinks 192 and 194.

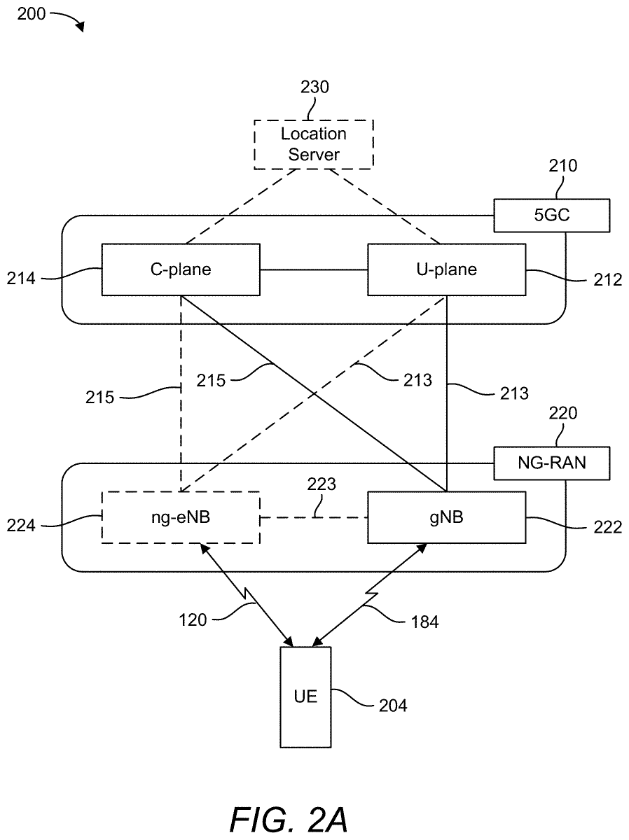

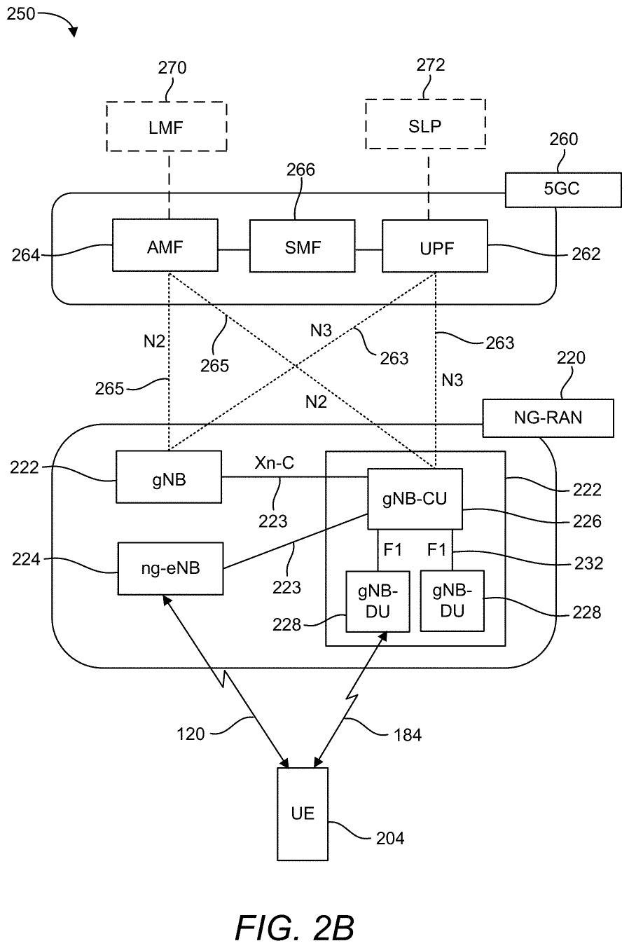

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

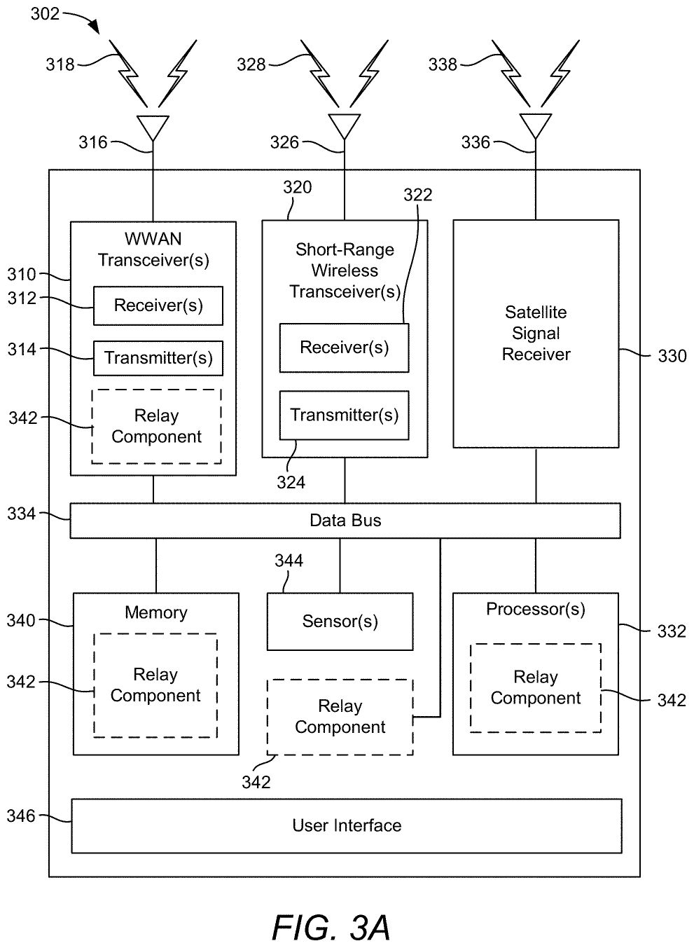

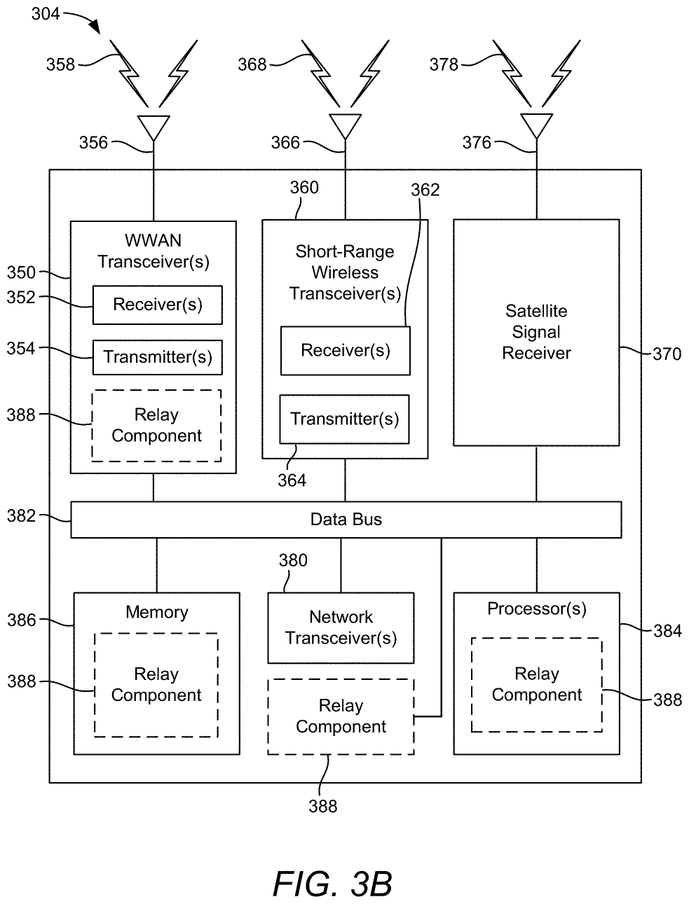

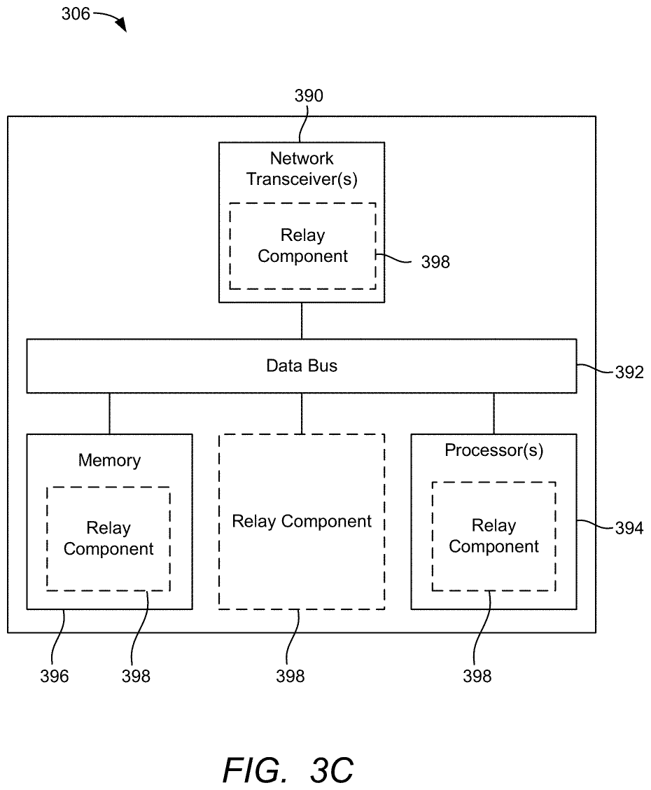

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include relay component 342, 388, and 398, respectively. The relay component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the relay component 342, 388, and 398 may be external to the processors 332, 384, and 394 (e.g., part of a modem processing system, integrated with another processing system, etc.). Alternatively, the relay component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the relay component 342, which may be, for example, part of the one or more WWAN transceivers 310, the memory 340, the one or more processors 332, or any combination thereof, or may be a standalone component. FIG. 3B illustrates possible locations of the relay component 388, which may be, for example, part of the one or more WWAN transceivers 350, the memory 386, the one or more processors 384, or any combination thereof, or may be a standalone component. FIG. 3C illustrates possible locations of the relay component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the relay component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

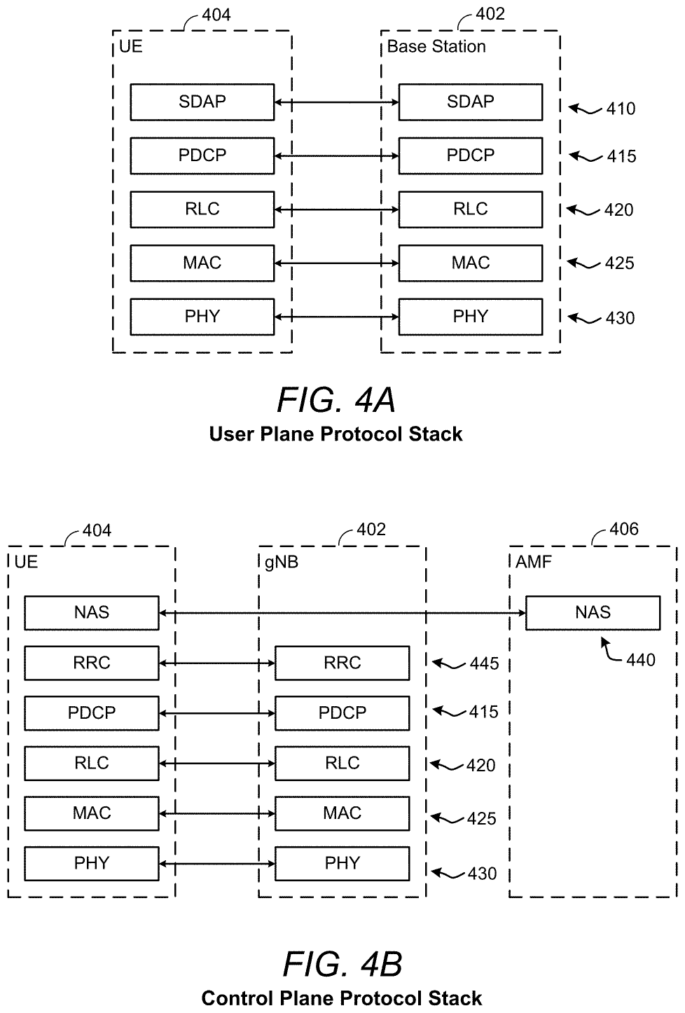

FIG. 4A illustrates a user plane protocol stack, according to aspects of the disclosure. As illustrated in FIG. 4A, a UE 404 and a base station 402 (which may correspond to any of the UEs and base stations, respectively, described herein) implement, from highest layer to lowest, a service data adaptation protocol (SDAP) layer 410, a packet data convergence protocol (PDCP) layer 415, a radio link control (RLC) layer 420, a medium access control (MAC) layer 425, and a physical (PHY) layer 430. Particular instances of a protocol layer are referred to as protocol “entities.” As such, the terms “protocol layer” and “protocol entity” may be used interchangeably.

As illustrated by the double-arrow lines in FIG. 4A, each layer of the protocol stack implemented by the UE 404 communicates with the same layer of the base station 402, and vice versa. The two corresponding protocol layers/entities of the UE 404 and the base station 402 are referred to as “peers,” “peer entities,” and the like. Collectively, the SDAP layer 410, the PDCP layer 415, the RLC layer 420, and the MAC layer 425 are referred to as “Layer 2” or “L2.” The PHY layer 430 is referred to as “Layer 1” or “L1.”

FIG. 4B illustrates a control plane protocol stack, according to aspects of the disclosure. In addition to the PDCP layer 415, the RLC layer 420, the MAC layer 425, and the PHY layer 430, the UE 404 and the base station 402 also implement a radio resource control (RRC) layer 445. Further, the UE 404 and an AMF 406 implement a non-access stratum (NAS) layer 440.

The RLC layer 420 supports three transmission modes for packets: transparent mode (TM), unacknowledged mode (UM), and acknowledged mode (AM). In TM mode, there is no RLC header, no segmentation/reassembly, and no feedback (i.e., no acknowledgment (ACK) or negative acknowledgment (NACK)). In addition, there is buffering at the transmitter only. In UM mode, there is an RLC header, buffering at both the transmitter and the receiver, and segmentation/reassembly, but no feedback (i.e., a data transmission does not require any reception response (e.g., ACK/NACK) from the receiver). In AM mode, there is an RLC header, buffering at both the transmitter and the receiver, segmentation/reassembly, and feedback (i.e., a data transmission requires a reception response (e.g., ACK/NACK) from the receiver). Each of these modes can be used to both transmit and receive data. In TM and UM modes, a separate RLC entity is used for transmission and reception, whereas in AM mode, a single RLC entity performs both transmission and reception. Note that each logical channel uses a specific RLC mode. That is, the RLC configuration is per logical channel with no dependency on numerologies and/or transmission time interval (TTI) duration (i.e., the duration of a transmission on the radio link). Specifically, the broadcast control channel (BCCH), paging control channel (PCCH), and common control channel (CCCH) use TM mode only, the dedicated control channel (DCCH) uses AM mode only, and the dedicated traffic channel (DTCH) uses UM or AM mode. Whether the DTCH uses UM or AM is determined by RRC messaging.

The main services and functions of the RLC layer 420 depend on the transmission mode and include transfer of upper layer protocol data units (PDUs), sequence numbering independent of the one in the PDCP layer 415, error correction through automatic repeat request (ARQ), segmentation and re-segmentation, reassembly of service data units (SDUs), RLC SDU discard, and RLC re-establishment. The ARQ functionality provides error correction in AM mode, and has the following characteristics: ARQ retransmissions of RLC PDUs or RLC PDU segments based on RLC status reports, polling for an RLC status report when needed by RLC, and RLC receiver triggering of an RLC status report after detection of a missing RLC PDU or RLC PDU segment.

The main services and functions of the PDCP layer 415 for the user plane include sequence numbering, header compression and decompression (for robust header compression (ROHC)), transfer of user data, reordering and duplicate detection (if in-order delivery to layers above the PDCP layer 415 is required), PDCP PDU routing (in case of split bearers), retransmission of PDCP SDUs, ciphering and deciphering, PDCP SDU discard, PDCP re-establishment and data recovery for RLC AM, and duplication of PDCP PDUs. The main services and functions of the PDCP layer 415 for the control plane include ciphering, deciphering, and integrity protection, transfer of control plane data, and duplication of PDCP PDUs.

The SDAP layer 410 is an access stratum (AS) layer, the main services and functions of which include mapping between a quality of service (QoS) flow and a data radio bearer and marking QoS flow identifier in both downlink and uplink packets. A single protocol entity of SDAP is configured for each individual PDU session.

The main services and functions of the RRC layer 445 include broadcast of system information related to AS and NAS, paging initiated by the 5GC (e.g., NGC 210 or 260) or RAN (e.g., NG-RAN 220), establishment, maintenance, and release of an RRC connection between the UE and RAN, security functions including key management, establishment, configuration, maintenance, and release of signaling radio bearers (SRBs) and data radio bearers (DRBs), mobility functions (including handover, UE cell selection and reselection and control of cell selection and reselection, context transfer at handover), QoS management functions, UE measurement reporting and control of the reporting, and NAS message transfer to/from the NAS from/to the UE.

The NAS layer 440 is the highest stratum of the control plane between the UE 404 and the AMF 406 at the radio interface. The main functions of the protocols that are part of the NAS layer 440 are the support of mobility of the UE 404 and the support of session management procedures to establish and maintain Internet protocol (IP) connectivity between the UE 404 and the packet data network (PDN). The NAS layer 440 performs evolved packet system (EPS) bearer management, authentication, EPS connection management (ECM)-IDLE mobility handling, paging origination in ECM-IDLE, and security control.

After a random access procedure, the UE is in an RRC CONNECTED state. The RRC protocol is used on the air interface between a UE and a base station. The major functions of the RRC protocol include connection establishment and release functions, broadcast of system information, radio bearer establishment, reconfiguration, and release, RRC connection mobility procedures, paging notification and release, and outer loop power control. In LTE, a UE may be in one of two RRC states (CONNECTED or IDLE), but in NR, a UE may be in one of three RRC states (CONNECTED, IDLE, or INACTIVE). The different RRC states have different radio resources associated with them that the UE can use when it is in a given state. Note that the different RRC states are often capitalized, as above; however, this is not necessary, and these states can also be written in lowercase.

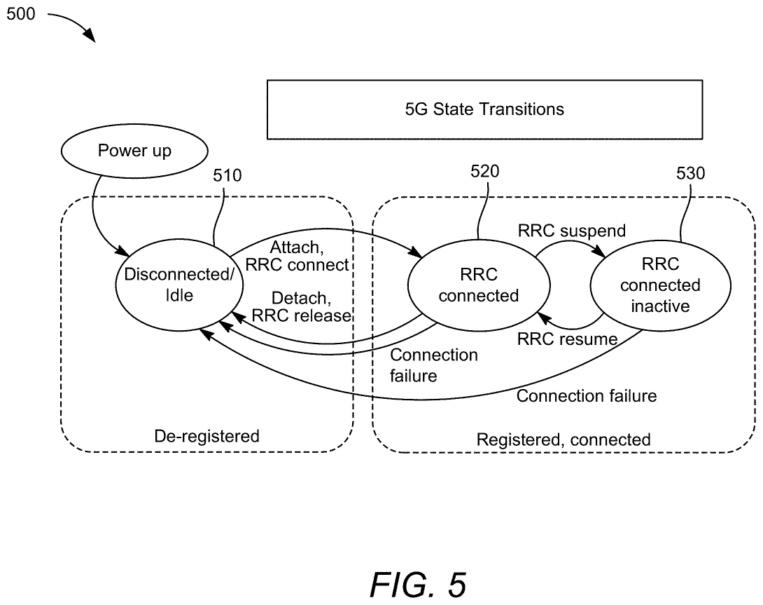

FIG. 5 is a diagram 500 of the different RRC states (also referred to as RRC modes) available in NR, according to aspects of the disclosure. When a UE is powered up, it is initially in the RRC DISCONNECTED/IDLE state 510. After a random access procedure, it moves to the RRC CONNECTED state 520. If there is no activity at the UE for a short time, it can suspend its session by moving to the RRC INACTIVE state 530. The UE can resume its session by performing a random access procedure to transition back to the RRC CONNECTED state 520. Thus, the UE needs to perform a random access procedure to transition to the RRC CONNECTED state 520, regardless of whether the UE is in the RRC IDLE state 510 or the RRC INACTIVE state 530.

The operations performed in the RRC IDLE state 510 include public land mobile network (PLMN) selection, broadcast of system information, cell re-selection mobility, paging for mobile terminated data (initiated and managed by the 5GC), discontinuous reception (DRX) for core network paging (configured by non-access stratum (NAS)). The operations performed in the RRC CONNECTED state 520 include 5GC (e.g., 5GC 260) and NG-RAN (e.g., NG-RAN 220) connection establishment (both control and user planes), UE context storage at the NG-RAN and the UE, NG-RAN knowledge of the cell to which the UE belongs, transfer of unicast data to/from the UE, and network controlled mobility. The operations performed in the RRC INACTIVE state 530 include the broadcast of system information, cell re-selection for mobility, paging (initiated by the NG-RAN), RAN-based notification area (RNA) management (by the NG-RAN), DRX for RAN paging (configured by the NG-RAN), 5GC and NG-RAN connection establishment for the UE (both control and user planes), storage of the UE context in the NG-RAN and the UE, and NG-RAN knowledge of the RNA to which the UE belongs.

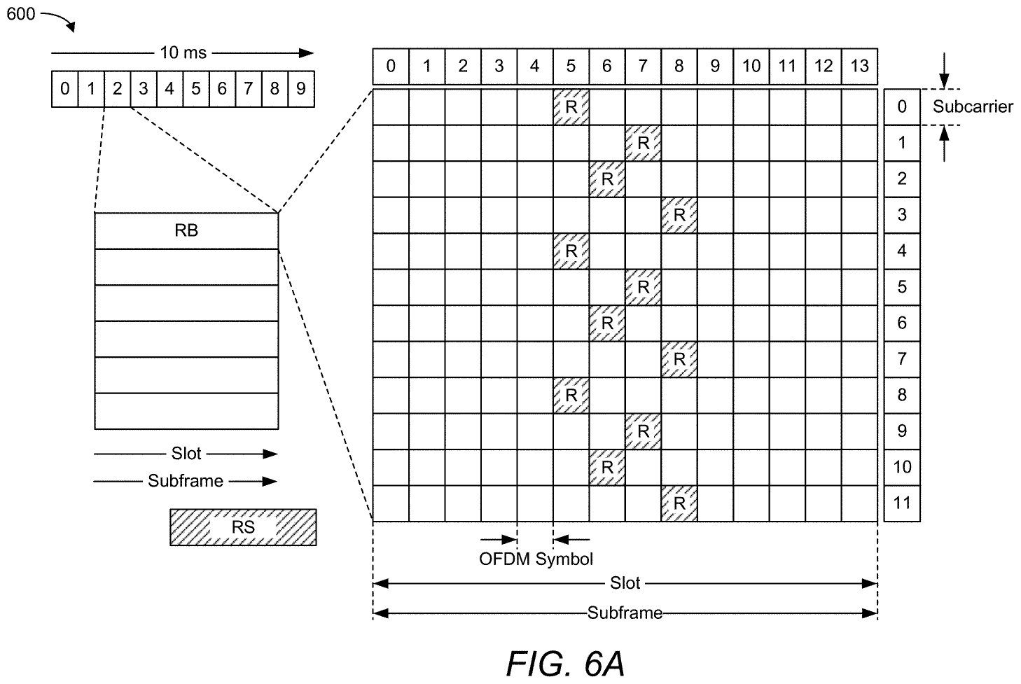

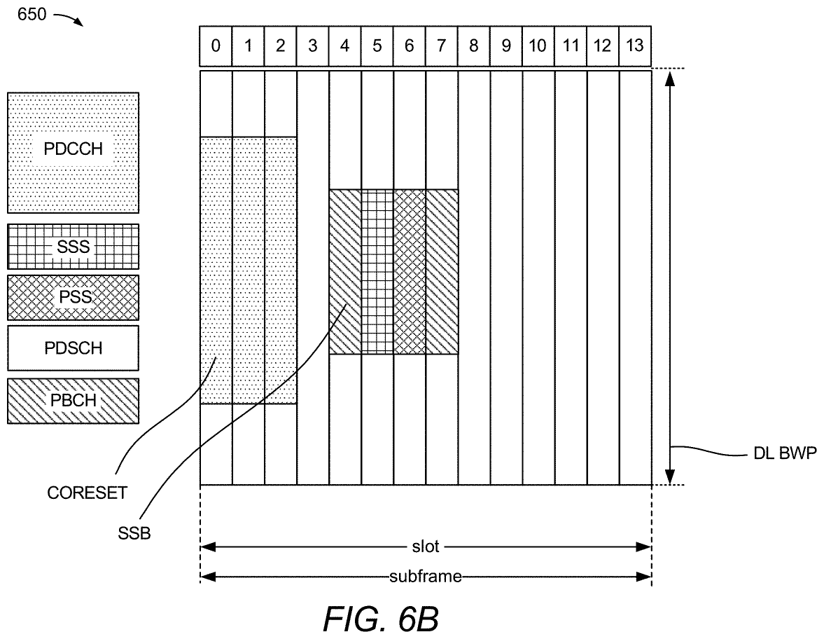

Various frame structures may be used to support downlink and uplink transmissions between network nodes (e.g., base stations and UEs). FIG. 6A is a diagram 600 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6A, a numerology of 15 kHz is used. Thus, in the time domain, a 10 ms frame is divided into 10 equally sized subframes of 1 ms each, and each subframe includes one time slot. In FIG. 6A, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6A, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6A illustrates example locations of REs carrying a reference signal (labeled “R”).

FIG. 6B is a diagram 650 illustrating various downlink channels within an example downlink slot. In FIG. 6B, time is represented horizontally (on the X axis) with time increasing from left to right, while frequency is represented vertically (on the Y axis) with frequency increasing (or decreasing) from bottom to top. In the example of FIG. 6B, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 6B, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

A base station (more specifically, a cell or TRP of a base station) periodically transmits MIBs and SIBs to enable a UE to access the network/RAN through the base station. A MIB may be transmitted with the periodicity of 80 ms, with repetitive transmissions within this 80 ms periodicity. A MIB includes the parameters needed to decode a SIB Type 1 (SIB1). The MIB and SIB1 are the first two RRC messages of an RRC session. A SIB1 may be transmitted with a periodicity of 160 ms, with repetitive transmissions within this 160 ms periodicity. A SIB1 includes information regarding the availability and scheduling (e.g., periodicity) of other SIB types (e.g., SIB2, SIB3, etc.) and whether the other SIB types are transmitted periodically or on-demand. If the other SIB types are transmitted on-demand, then the SIB1 includes information for the UE to perform an SI request.

Paging is the mechanism whereby the network informs the UE that it has data for the UE. In most cases, the paging process occurs while the UE is in the IDLE or INACTIVE states (e.g., RRC IDLE state 510, RRC INACTIVE state 530). This means that the UE needs to monitor whether the network is transmitting any paging message to it. Specifically, during the IDLE state, the UE enters the sleep mode defined in its DRX cycle (defined in SIB2). The UE periodically wakes up and monitors the physical downlink control channel (PDCCH) to check for the presence of a paging message on the PDCCH. If the PDCCH indicates that a paging message is transmitted in the subframe, then the UE needs to demodulate the paging channel (PCH) to see if the paging message is directed to it.

The PDCCH also carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 6B, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 6B is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

Proximity services (referred to as “ProSe”) have been introduced in LTE and 5G. ProSe is a D2D technology that allows ProSe-enabled UEs to “discover” each other and to communicate with each other directly (e.g., over a sidelink or via the same serving base station). For example, UE 190 and UE 104 in FIG. 1 may be examples of ProSe-enabled UEs. ProSe Direct Discovery procedures identify ProSe-enabled UEs that are in proximity to each another. ProSe Direct Communication procedures enable the establishment of communication paths between two or more ProSe-enabled UEs that are in direct wireless communication range. The ProSe Direct Communication path may be through the RAN (e.g., a shared serving base station) or over a unicast sidelink (e.g., sidelinks 192, 194) between the involved UEs.

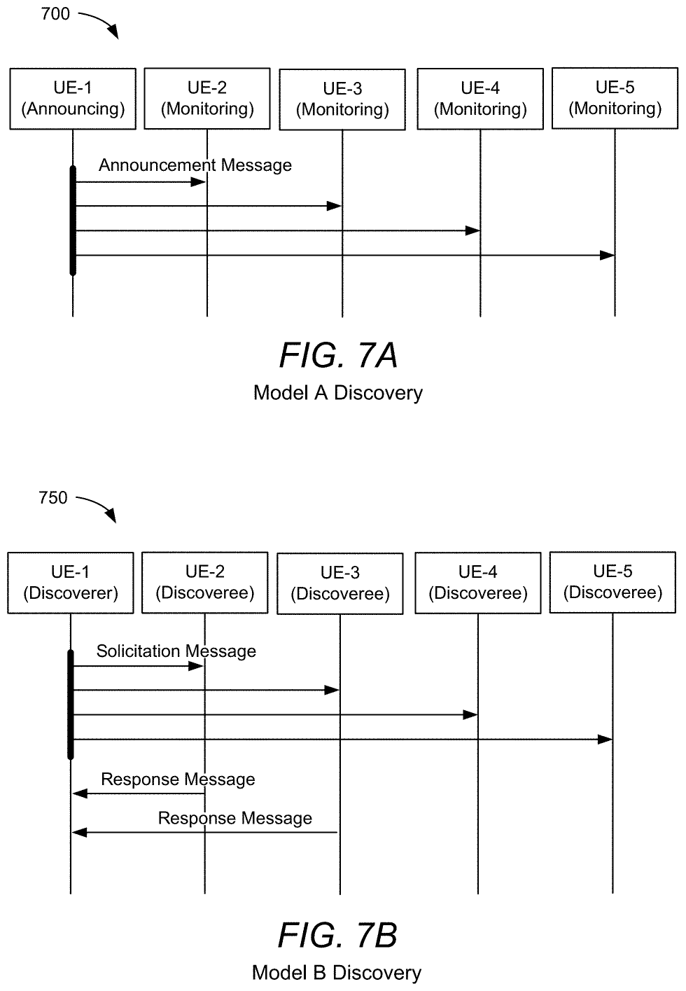

5G supports two types of ProSe Direct Discovery procedures, “Model A” and “Model B.” These Direct Discovery procedures are defined in 3GPP Technical Report (TR) 23.752, which is publicly available and incorporated by reference herein in its entirety. FIG. 7A illustrates an example call flow 700 for Model A discovery, and FIG. 7B illustrates an example call flow 750 for Model B discovery. As illustrated in FIG. 7A, for Model A discovery, an announcing UE (labeled “UE-1”) sends announcement messages to one or more monitoring UEs (labeled “UE-2,” “UE-3,” “UE-4,” and “UE-5”). In contrast, as illustrated in FIG. 7B, a discoverer UE (labeled “UE-1”) sends a solicitation message to one or more discoveree UEs (labeled “UE-2,” “UE-3,” “UE-4,” and “UE-5”). Discoveree UEs (“UE-2” and “UE-3” in the example of FIG. 7B) interested in establishing a sidelink with the discoverer UE respond to the solicitation message with a response message.

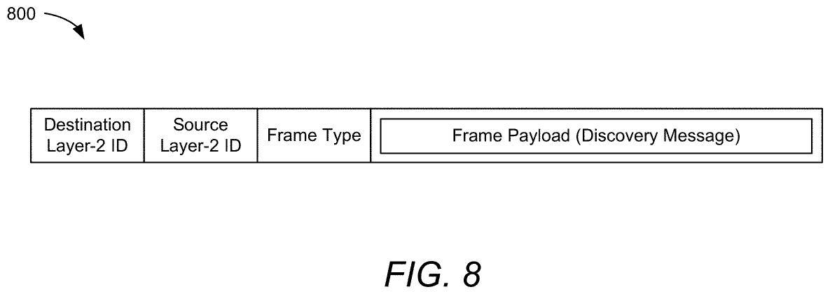

The discovery messages (whether announcement messages or solicitation messages) are sent over a PC5 communication channel and not over a separate discovery channel. Discovery messages may be carried within the same Layer-2 frames as those used for ProSe Direct Communication. FIG. 8 is a diagram 800 of a simplified Layer-2 frame format for ProSe Direct Discovery messages. The “Destination Layer-2 ID” field can be set to a unicast, groupcast, or broadcast identifier. The “Source Layer-2 ID” field is set to a unicast identifier of the transmitter (e.g., “UE-1” in FIGS. 7A and 7B). The “Frame Type” field indicates that it is a ProSe Direct Discovery message.

5G also supports UE-to-network relaying, in which a ProSe-capable “relay” UE forwards downlink network traffic from the RAN to a ProSe-capable “remote” UE, and forwards uplink user data from the remote UE to the RAN. Relay discovery in 5G leverages the existing LTE ProSe relay discovery procedures, i.e., both Model A (announcement) and Model B (solicitation and response) restricted discovery, as illustrated in FIGS. 7A and 7B. The UE 190 in FIG. 1 may be an example of a remote UE and the UE 104 to which it is connected over sidelink 192 may be an example of a relay UE.

Relay service codes are used to identify the connectivity service(s) a ProSe relay UE may provide. A remote UE interested in a UE-to-network relay for a particular relay service attempts to discover a relay UE offering that relay service by monitoring for discovery messages from relay UEs that include a relay service code matching the desired relay service. Different relay service codes may be assigned for different PC5 services (e.g., for public safety police members, public safety firefighters, network controlled interactive service (NCIS) gaming, NCIS virtual conferencing, etc.). Relay service codes may be provisioned to a UE by the original equipment manufacturer (OEM), the policy control function (PCF) during Uu (the air interface between the UE and the RAN) registration, or the like. Security information for discovery messages may be provisioned during the key management process.

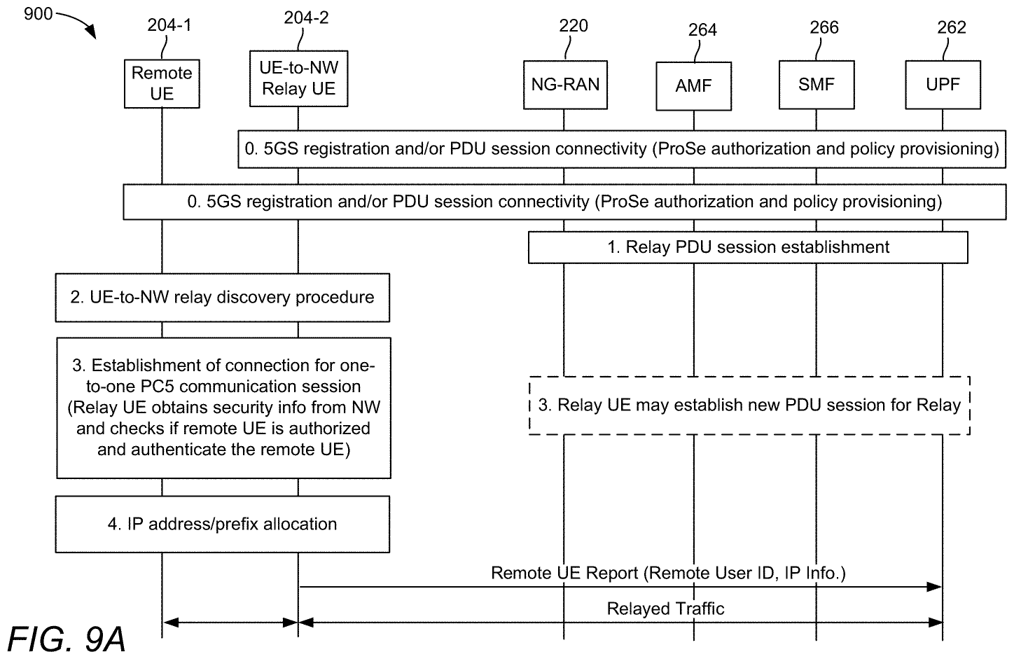

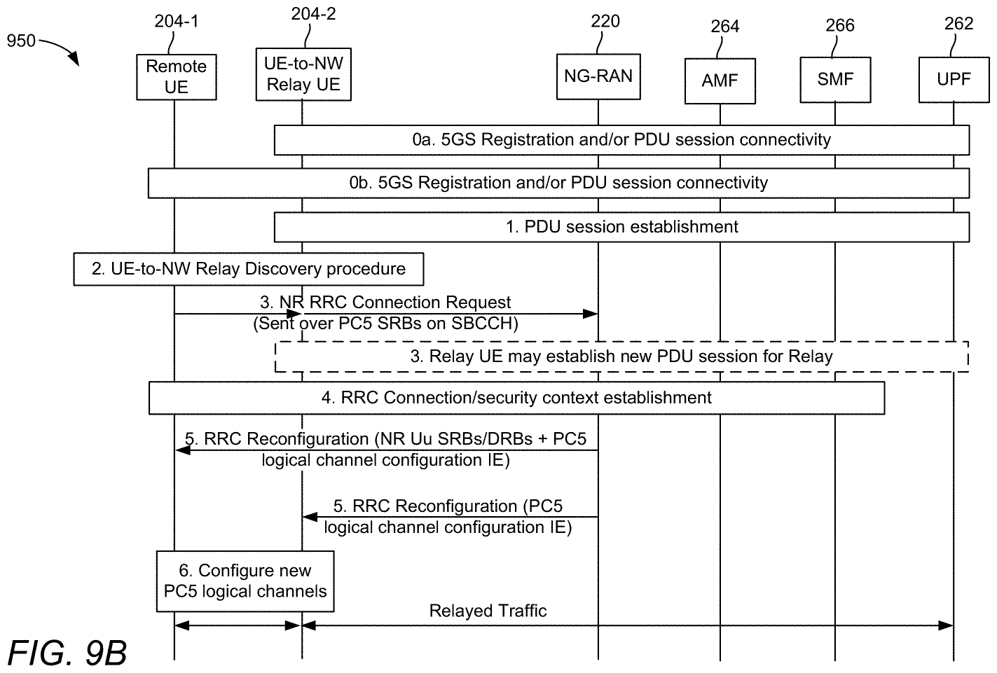

A relay UE can provide Layer-2 or Layer-3 relaying between a network entity (e.g., a base station) and a remote UE. FIG. 9A illustrates an example call flow 900 showing Layer-3 procedures for UE-to-network relay establishment. The remote UE 204-1 and the relay UE 204-2 (labeled “UE-to-NW Relay UE”) illustrated in FIG. 9A may correspond to any of the UEs described herein.

At stage 0, the remote UE 204-1 and the relay UE 204-2 register with the 5G system (5GS) and/or establish PDU session connectivity. The Layer-3 entities (e.g., the RRC layer 445 and/or the NAS layer 440) of the relay UE 204-2 may establish a dedicated PDU session associated with one or more relay service codes. As such, at stage 1, the relay UE 204-2 performs a separate relay PDU session establishment for each relay service the relay UE 204-2 supports. At stage 2, the remote UE 204-1 and the relay UE 204-2 perform a discovery procedure, such as a Model A or Model B discovery procedure illustrated in FIGS. 7A and 7B.

At stage 3, the remote UE 204-1 establishes a PC5-S unicast sidelink with the relay UE 204-2, and at stage 4, obtains an IP address. The PC5 unicast sidelink AS configuration is managed using PC5-RRC. The relay UE 204-2 and the remote UE 204-1 coordinate on the AS configuration. The relay UE 204-2 may consider information from the NG-RAN 220 (e.g., the base station serving the relay UE 204-2) to configure the PC5 sidelink. Whether the remote UE 204-1 is authenticated and/or authorized to access relay services is performed during the PC5 sidelink establishment. Also at stage 3, the relay UE 204-2 may establish a new PDU session for the relay UE 204-2. This may be a PDU session for another relay service code. After stage 4, the relay UE 204-2 performs Layer-3 relaying for the remote UE 204-1.

FIG. 9B illustrates an example call flow 950 showing Layer-2 procedures for UE-to-network relay establishment. The remote UE 204-1 and the relay UE 204-2 (labeled “UE-to-NW Relay UE”) illustrated in FIG. 9B may correspond to any of the UEs described herein.

In the call flow 950, there is no PC5 unicast sidelink setup prior to relaying. At stage 0, the remote UE 204-1 and the relay UE 204-2 register with the 5GS and/or establish PDU session connectivity. The Layer-2 entity (e.g., the SDAP layer 410, the PDCP layer 415, the RLC layer 420, and/or the MAC layer 425) of the relay UE 204-2 may establish a dedicated PDU session associated with one or more relay service codes. As such, at stage 1, the relay UE 204-2 performs a separate relay PDU session establishment for each relay service the relay UE 204-2 supports. At stage 2, the remote UE 204-1 and the relay UE 204-2 perform a discovery procedure, such as a Model A or Model B discovery procedure illustrated in FIGS. 7A and 7B.

At stage 3, the remote UE 204-1 sends an RRC connection request to the relay UE 204-2, which forwards it to the NG-RAN 220 (e.g., the base station serving the relay UE 204-2). The remote UE 204-1 sends the RRC messages over the sidelink broadcast control channel (SBCCH) on PC5 signaling radio bearers (SRBs). Also at stage 3, the relay UE 204-2 may establish a new PDU session for the relay UE 204-2. This may be a PDU session for another relay service code.

At stage 4, the remote UE 204-1 and the relay UE 204-2 perform RRC connection/security context establishment. At stage 5, the remote UE 204-1 and the relay UE 204-2 receive RRC reconfiguration messages from the RAN. The RAN can indicate the PC5 AS configuration to the remote UE 204-1 and the relay UE 204-2 independently via RRC messages.

At stage 6, the remote UE 204-1 and the relay UE 204-2 configure the new PC5 logical channels for the sidelink based on the RRC messages received at stage 5. Changes to V2X PC5 stack operation support radio bearer handling at the RRC/PDCP layers and support the corresponding logical channels of the PC5 sidelink. The PC5 RLC layer needs to support interaction with the PDCP layer directly.

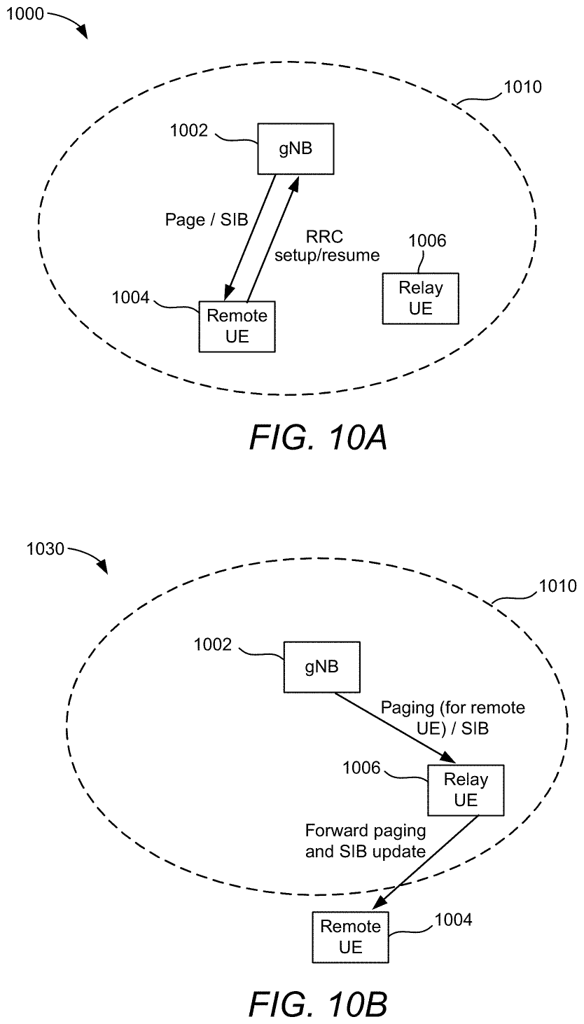

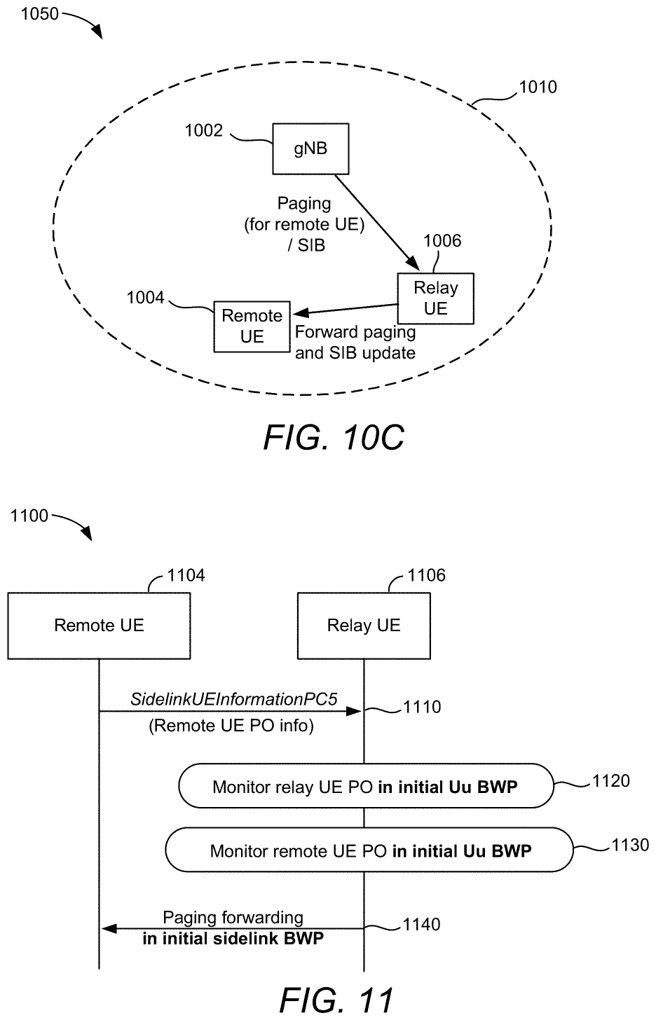

There are different ways that a remote UE can be paged by the network. A first type of paging in a UE-to-network relay scenario is direct paging. FIG. 10A is a diagram 1000 of a direct paging scenario. In the example of FIG. 10A, a remote UE 1004 (e.g., any of the UEs described herein) and a relay UE 1006 (e.g., any other of the UEs described herein) are within the geographic coverage area 1010 of a serving base station 1002 (labeled “gNB,” and which may correspond to any of the base stations described herein). In a direct paging scenario, the remote UE 1004 monitors Uu paging (i.e., pages sent over the Uu air interface) and SIBs from the serving base station 1002, and therefore, the relay UE 1006 does not monitor the remote UE's 1004 paging. The remote UE 1004 also sends any RRC setup or RRC resume messages directly to the serving base station 1002.

When the remote UE 1004 moves out of the geographic coverage area 1010 of the serving base station 1002, if there are any “suitable” neighboring cells (as in normal handover behavior), the remote UE 1004 will perform cell (re)selection to that cell. Otherwise, the remote UE will operate in out-of-coverage (OOC) mode. That is, the remote UE 1004 will not monitor Uu paging/SIBs from the serving base station 1002, and instead, will use, for example, a V2X pre-configuration.

A second type of paging in a UE-to-network relay scenario is forward paging. In a forward paging scenario, the remote UE does not monitor Uu paging or SIB broadcasts from the RAN. Instead, the relay UE monitors for pages and SIBs and forwards them to the remote UE. Forward paging can be used when the remote UE is in-coverage (e.g., within geographic coverage area 1010) or out-of-coverage (e.g., outside geographic coverage area 1010). Forward paging can also be used when the remote UE is in the IDLE state (e.g., RRC IDLE state 510), the INACTIVE state (e.g., RRC INACTIVE state 530), or the CONNECTED state (e.g., RRC CONNECTED state 520).

There are two forward paging options, a separate paging option and an aggregated paging option. FIG. 10B is a diagram 1030 of a forward paging scenario in which separate paging is utilized. In the example of FIG. 10B, the relay UE 1006 from FIG. 10A is still within the geographic coverage area 1010 of the serving base station 1002, but the remote UE 1004 is now outside the geographic coverage area 1010.

In a separate paging scenario, the relay UE 1006 monitors the remote UE's 1004 paging frame (PF) and paging occasion (PO) within that PF. The PF and PO indicate the time period (e.g., one or more symbols, slots, subframes, etc.) during which the RAN (i.e., serving base station 1002 in the example of FIG. 10B) will transmit any pages for the remote UE 1004, and therefore, the time period the relay UE 1006 should monitor for pages for the remote UE 1004. As will be appreciated, the PF and PO are configured to occur periodically. Although both the PF and PO are needed to determine the time at which to monitor for pages, for simplicity, often only the PO is referenced. There is no change needed to the remote UE's 1004 existing PF and PO calculation, the relay UE 1006 simply needs to be informed of the remote UE's 1004 paging PO.

FIG. 10C is a diagram 1050 of a forward paging scenario in which aggregated paging is utilized. In the example of FIG. 10C, the relay UE 1006 from FIG. 10A is still within the geographic coverage area 1010 of the serving base station 1002, and the remote UE 1004 has returned the geographic coverage area 1010 (to illustrate that forward paging can be used whether the remote UE 1004 is in-coverage or out-of-coverage).

In an aggregated paging scenario, the serving base station 1002 aggregates the pages for the remote UE 1004 together with any pages for the relay UE 1006. More specifically, the serving base station 1002 will transmit any pages for the remote UE 1004 during the relay UE's 1006 paging PF and PO occasions. In this scenario, any page needs to include an indication of the UE (the remote UE 1004 or the relay UE 1006) for which the page is intended.

An issue with forward paging is that it is not clear which BWP the relay UE should monitor for the remote UE's paging. A first scenario is where both the relay UE and the remote UE are in the INACTIVE state (e.g., RRC INACTIVE state 530) or the IDLE state (e.g., RRC IDLE state 510). A second scenario is where the relay UE is in the CONNECTED state (e.g., RRC CONNECTED state 520) and the remote UE is in the INACTIVE or IDLE state. A third scenario is where both the relay UE and the remote UE are in the CONNECTED state. A fourth scenario is where both UEs are in the CONNECTED state and the remote UE is receiving a dedicated downlink data stream from the serving base station. In this scenario, it may not be clear which BWP the remote UE should monitor for its dedicated data transmission from the relay UE. For example, the base station may or may not be able to indicate the BWP used for sidelink transmission between the UEs.

The present disclosure provides different BWP models for determining which BWP to monitor in a UE-to-network relay scenario. A first BWP model disclosed herein is the Uu BWP model. In this model, the remote and relay UEs, when in the IDLE or INACTIVE states, access the serving base station (more specifically, a cell or TRP of the serving base station) via the initial Uu BWP for that base station/cell/TRP. The initial Uu BWP (or “initial downlink BWP” or “initial uplink BWP,” or simply “initial BWP”) is the active BWP to be used by a UE during initial cell access and until the base station explicitly configures the UE with BWPs during or after RRC connection establishment. The initial active BWP is the default BWP, unless or until a UE is configured otherwise. After entering the CONNECTED state, the base station can use DCI and/or RRC signaling to indicate a BWP switch for an active data transmission to the remote UE.

A second BWP model disclosed herein is the sidelink BWP model. In this model, it is assumed that more than one sidelink BWP can be configured by SIB (e.g., SIB1) and/or RRC signaling, or may be preconfigured, similar to Uu. The intention is to achieve power savings and reduce interference between multiple remote UEs that are scheduled by different relay UEs. In the current standard, a transmission and reception resource pool is configured in one BWP. Then, the BWP in which the remote UE and the relay UE complete relay selection is regarded as the “initial sidelink BWP.” After the PC5 RRC connection between the remote UE and the relay UE is established, the relay UE can use sidelink control information (SCI) to indicate a switch from the initial sidelink BWP to a different sidelink BWP.

FIG. 11 illustrates an example call flow 1100 of a forward paging scenario in which both a relay UE 1106 and a remote UE 1104 are in an INACTIVE or IDLE state. The remote UE 1104 and the relay UE 1106 may correspond to any of the UEs described herein. For example, the remote UE 1104 may correspond to remote UE 1004 and the relay UE 1106 may correspond to relay UE 1006.

At 1110, the remote UE 1104 transmits its PO-related information to the relay UE 1106 via a PC5 RRC message (e.g., the “SidelinkUEInformationPC5” information element (IE)). The PO-related information may be the remote UE's 1104 PO, or the paging cycle and an identifier of the remote UE 1104. The identifier of the remote UE may be, for example, a hashed international mobile subscriber identity (IMSI) or an inactive radio network temporary identifier (I-RNTI) of the remote UE 1104. The hash function may be configured via a dedicated Uu RRC message, or SIB, or pre-configured. In an aspect, the identifier of the remote UE 1104 may be provided by the AMF (e.g., AMF 264), rather than the remote UE 1104.

At 1120 and 11130, the relay UE 1106 monitors its PO and the remote UE's 1104 PO in the initial Uu BWP for any pages from the serving base station (or more specifically, a serving cell or TRP of the serving base station). As in the existing NR paging procedure, the serving base station pages all the IDLE/INACTIVE UEs in the initial BWP (and hence, the relay UE 1106 monitors the initial BWP for paging). At 1140, the relay UE 1106 forwards any pages from the network to the remote UE 1104 in the initial sidelink BWP (because the remote UE 1104 is in the INACTIVE or IDLE state and is therefore only monitoring the initial BWP). The relay UE 1106 may forward the page(s) via a dedicated PC5 RRC message (if for dedicated data) or a broadcast/groupcast PC5 message (if for a SIB update or an emergency).

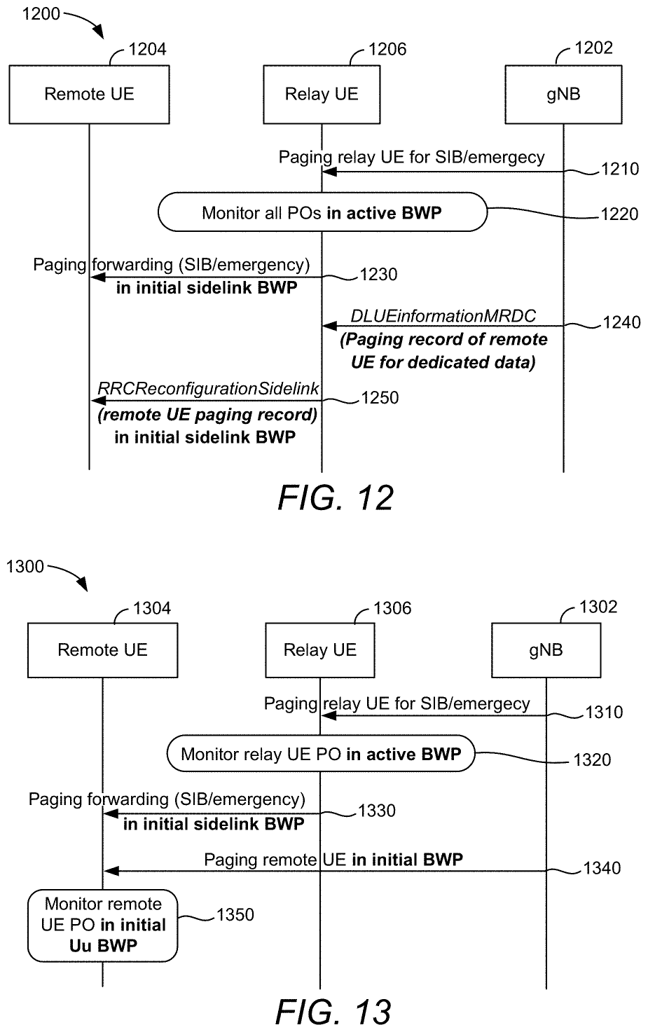

FIG. 12 illustrates an example call flow 1200 of a forward paging scenario in which a relay UE 1206 is in a CONNECTED state and a remote UE 1204 is in an INACTIVE or IDLE state. The remote UE 1204 and the relay UE 1206 may correspond to any of the UEs described herein. For example, the remote UE 1204 may correspond to remote UE 1004 and the relay UE 1206 may correspond to relay UE 1006. The remote UE 1204 and the relay UE 1206 are served by a base station 1202 (labeled “gNB”), or more specifically, a cell or TRP of the base station 1202. The base station 1202 may correspond to any of the base stations described herein.

At 1210, the base station 1202 broadcasts a SIB update or an emergency page for the UEs in its coverage area, including the relay UE 1206. At 1220, the relay UE 1206 detects the page by monitoring all POs (both the relay UE's 1206 and the remote UE's 1204) in its active BWP. At 1230, upon reception of the page, the relay UE 1206 forwards the page to the remote UE 1204 in the initial sidelink BWP (since the remote UE 1204 is in an INACTIVE or IDLE state). Because the page is not dedicated for the remote UE 1204, the relay UE 1206 may forward the page over the sidelink using a dedicated, broadcast, or groupcast PC5 message.

At 1240, the base station 1202 transmits a dedicated page for the remote UE 1204 in the active BWP of the relay UE 1306. The page includes a paging record for the remote UE 1204 that indicates that the page includes dedicated data for the remote UE 1204. For example, the page may be an RRC message including the “DLUEinformationMRDC” IE to indicate that it is a dedicated page for the remote UE 1204. At 1250, upon reception of the page, the relay UE 1206 forwards the page to the remote UE 1204 using a dedicated PC5 message in the initial sidelink BWP (since the remote UE 1204 is in an INACTIVE or IDLE state). In the scenario illustrated in FIG. 12, the remote UE 1204 does not monitor for paging.

FIG. 13 illustrates an example call flow 1300 of a forward paging scenario in which a relay UE 1306 is in a CONNECTED state and a remote UE 1304 is in an INACTIVE or IDLE state. The remote UE 1304 and the relay UE 1306 may correspond to any of the UEs described herein. For example, the remote UE 1304 may correspond to remote UE 1004 and the relay UE 1306 may correspond to relay UE 1006. The remote UE 1304 and the relay UE 1306 are served by a base station 1302 (labeled “gNB”), or more specifically, a cell or TRP of the base station 1302. The base station 1302 may correspond to any of the base stations described herein.

At 1310, the base station 1302 broadcasts a SIB update or an emergency page for the UEs in its coverage area, including the relay UE 1306. At 1320, the relay UE 1306 detects the page by monitoring its PO in its active BWP. At 1330, upon reception of the page in its active BWP, the relay UE 1306 forwards the page to the remote UE 1304 in the initial sidelink BWP (since the remote UE 1304 is in an INACTIVE or IDLE state). Because the page is not dedicated for the remote UE 1304, the relay UE 1306 may forward the page over the sidelink using a dedicated, broadcast, or groupcast PC5 message.

In the scenario of FIG. 13, the relay UE 1306 does not forward pages dedicated for the remote UE 1304; rather, the remote UE 1304 monitors its paging in the initial BWP (since the remote UE 1304 is in an INACTIVE or IDLE state). Thus, at 1340, the base station 1302 transmits a dedicated page for the remote UE 1304 in the initial BWP. At 1350, the remote UE 1304 detects the page by monitoring its PO in the initial BWP. Because the base station 1302 pages the remote UE 1304 as it would if the remote UE 1304 were not connected to the relay UE 1306, there are no changes to the behavior of the base station 1302 due to the UE-to-network relay scenario.

Forward paging can also be used when both the relay UE and the remote UE are in a CONNECTED state. In this scenario, the relay UE follows the existing Uu paging monitoring behavior. That is, the relay UE monitors for SI update notifications and emergency notifications in any PO (if the relay UE is provided with a common search space to monitor paging in the CONNECTED state). Upon reception of a SIB update or an emergency notification in the relay UE's active BWP, the relay UE forwards the page to the remote UE in the active sidelink BWP (because both UEs are in a CONNECTED state) using a dedicated, broadcast, or groupcast PC5 message. The remote UE does not monitor for this type of paging.

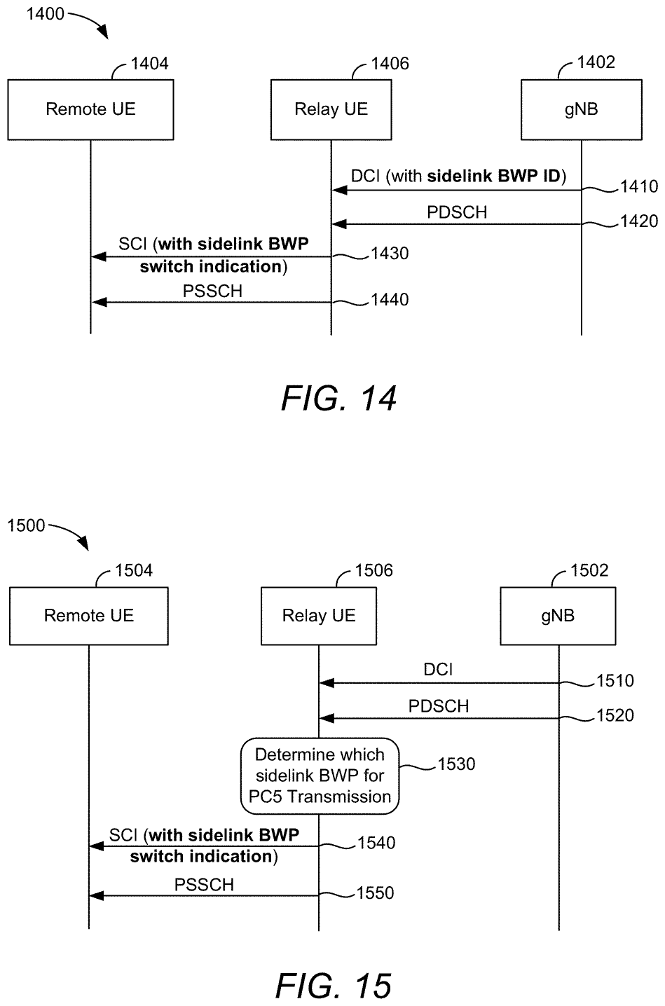

Data transmission to the remote UE when both the relay UE and the remote UE are in the CONNECTED state may be controlled by the base station or the relay UE. FIG. 14 is an example of base station-controlled data transmission to a remote UE, and FIG. 15 is an example of relay-controlled data transmission to a remote UE.

FIG. 14 illustrates an example call flow 1400 of a forward paging scenario in which both a relay UE 1406 and a remote UE 1404 are in a CONNECTED state. The remote UE 1404 and the relay UE 1406 may correspond to any of the UEs described herein. For example, the remote UE 1404 may correspond to remote UE 1004 and the relay UE 1406 may correspond to relay UE 1006. The remote UE 1404 and the relay UE 1406 are served by a base station 1402 (labeled “gNB”), or more specifically, a cell or TRP of the base station 1402. The base station 1402 may correspond to any of the base stations described herein.

At 1410, the base station 1402 transmits DCI to the relay UE 1406. The DCI indicates a sidelink BWP ID for a downlink grant for the relay UE 1406 to receive PDSCH data for the remote UE 1404. At 1420, the base station transmits the PDSCH data for the remote UE 1404. At 1430, the relay UE 1406 transmits SCI to the remote UE 1404 to instruct the remote UE 1404 to switch the current (initial or active) sidelink BWP to the one indicated by the base station 1402 in the DCI. At 1440, the relay UE 1406 uses the indicated BWP to transmit the PDSCH data to the remote UE 1404 as a PC5 transmission on a physical sidelink shared channel (PSSCH).

For uplink data transmission from the remote UE 1404 to the base station 1402, the grant at 1410 would be an uplink grant for a PUSCH. Operation 1420 would not occur, but operations 1430 would be the same. For operation 1440, instead of the relay UE 1406 sending downlink data to the remote UE 1404, the remote UE 1404 would send uplink data to the relay UE 1406. The uplink data would still be sent over the PSSCH in the DCI-indicated BWP. The relay UE 1406 would then send the uplink data from the remote UE 1404 to the base station 1402 over the allocated PUSCH.

FIG. 15 illustrates an example call flow 1500 of a forward paging scenario in which both a relay UE 1506 and a remote UE 1504 are in a CONNECTED state. The remote UE 1504 and the relay UE 1506 may correspond to any of the UEs described herein. For example, the remote UE 1504 may correspond to remote UE 1004 and the relay UE 1506 may correspond to relay UE 1006. The remote UE 1504 and the relay UE 1506 are served by a base station 1502 (labeled “gNB”), or more specifically, a cell or TRP of the base station 1502. The base station 1502 may correspond to any of the base stations described herein.

At 1510, the base station 1502 transmits DCI to the relay UE 1406. The DCI indicates a downlink grant for the relay UE 1506 to receive PDSCH data for the remote UE 1504. For a relay-controlled data transmission scenario, as in FIG. 15, there is no change needed to the existing DCI for a downlink grant to the relay UE 1506. At 1520, the base station transmits the PDSCH data for the remote UE 1504 to the relay UE 1506. At 1530, the relay UE 1506 determines which sidelink BWP to use to transmit the PDSCH data to the remote UE 1504 as a PC5 data stream over the sidelink. At 1540, the relay UE 1506 transmits an indication of the selected BWP to the remote UE 1504 over the sidelink in SCI. In response, the remote UE 1504 switches from the current (initial or active) sidelink BWP to the one indicated in the SCI from the relay UE 1506. At 1550, the relay UE 1506 uses the indicated BWP to transmit the PDSCH data to the remote UE 1504 as a PC5 transmission on a PSSCH.

For uplink data transmission from the remote UE 1504 to the base station 1502, the grant at 1510 would be an uplink grant for a PUSCH. Operation 1520 would not occur, but operations 1530 and 1540 would be the same. For operation 1550, instead of the relay UE 1506 sending downlink data to the remote UE 1504, the remote UE 1504 would send uplink data to the relay UE 1506. The uplink data would still be sent over the PSSCH in the relay-selected BWP. The relay UE 1506 would then send the uplink data from the remote UE 1504 to the base station 1502 over the allocated PUSCH.

Note that the order of the operations illustrated in FIGS. 11 to 15 is an example and the operations need not be performed in the illustrated order, except where an operation depends on the result of another operation.

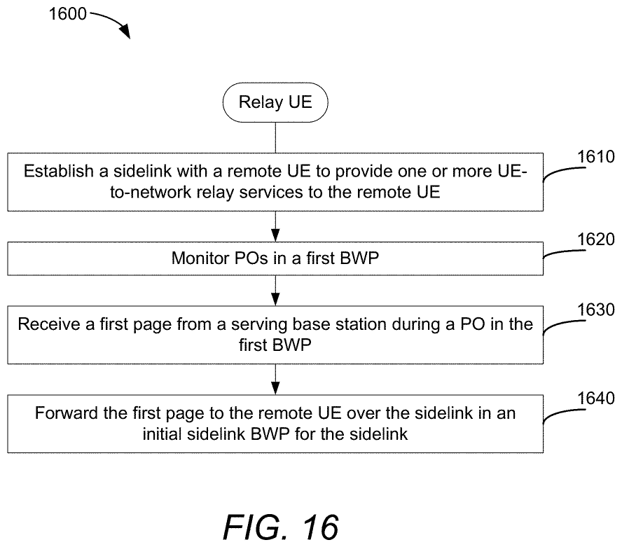

FIG. 16 illustrates an example method 1600 of wireless communication, according to aspects of the disclosure. In an aspect, the method 1600 may be performed by a relay UE (e.g., any of the UEs described herein).

At 1610, the relay UE establishes a sidelink with a remote UE (e.g., any other of the UEs described herein) to provide one or more UE-to-network relay services to the remote UE, as described above with reference to FIGS. 9A and 9B. In an aspect, operation 1610 may be performed by the one or more WWAN transceivers 310, the one or more processors 332, memory 340, and/or relay component 342, any or all of which may be considered means for performing this operation.

At 1620, the relay UE monitors POs in a first BWP, as described above with reference to, for example, operations 1120, 1130, 1220, and 1320. In an aspect, operation 1620 may be performed by the one or more WWAN transceivers 310, the one or more processors 332, memory 340, and/or relay component 342, any or all of which may be considered means for performing this operation.

At 1630, the relay UE receives a first page from a serving base station (e.g., any of the base stations described herein) during a PO in the first BWP, as described above with reference to, for example, operations 1210 and 1310. In an aspect, operation 1630 may be performed by the one or more WWAN transceivers 310, the one or more processors 332, memory 340, and/or relay component 342, any or all of which may be considered means for performing this operation.

At 1640, the relay UE forwards the first page to the remote UE over the sidelink in an initial sidelink BWP for the sidelink, as described above with reference to, for example, operations 1140, 1230, 1250, and 1330. In an aspect, operation 1640 may be performed by the one or more WWAN transceivers 310, the one or more processors 332, memory 340, and/or relay component 342, any or all of which may be considered means for performing this operation.

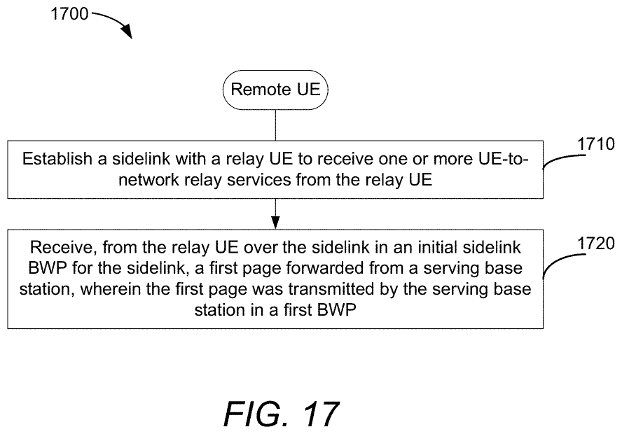

FIG. 17 illustrates an example method 1700 of wireless communication, according to aspects of the disclosure. In an aspect, the method 1700 may be performed by a remote UE (e.g., any of the UEs described herein).

At 1710, the remote UE establishes a sidelink with a relay UE (e.g., any other of the UEs described herein) to receive one or more UE-to-network relay services from the relay UE, as described above with reference to FIGS. 9A and 9B. In an aspect, operation 1710 may be performed by the one or more WWAN transceivers 310, the one or more processors 332, memory 340, and/or relay component 342, any or all of which may be considered means for performing this operation.

At 1720, the remote UE receives, from the relay UE over the sidelink in an initial sidelink BWP for the sidelink, a first page forwarded from a serving base station (e.g., any of the base stations described herein), wherein the first page was transmitted by the serving base station in a first BWP, as described above with reference to, for example, operations 1140, 1230, 1250, and 1330. In an aspect, operation 1720 may be performed by the one or more WWAN transceivers 310, the one or more processors 332, memory 340, and/or relay component 342, any or all of which may be considered means for performing this operation.

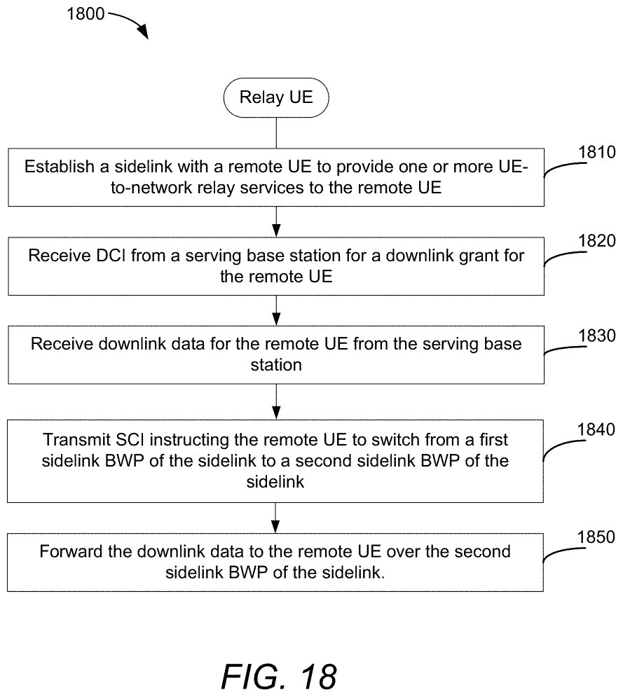

FIG. 18 illustrates an example method 1800 of wireless communication, according to aspects of the disclosure. In an aspect, the method 1800 may be performed by a relay UE (e.g., any of the UEs described herein).

At 1810, the relay UE establishes a sidelink with a remote UE to provide one or more UE-to-network relay services to the remote UE, as described above with reference to FIGS. 9A and 9B. In an aspect, operation 1810 may be performed by the one or more WWAN transceivers 310, the one or more processors 332, memory 340, and/or relay component 342, any or all of which may be considered means for performing this operation.

At 1820, the relay UE receives DCI from a serving base station (e.g., any of the base stations described herein) for a downlink grant for the remote UE, as described above with reference to, for example, operations 1410 and 1510. In an aspect, operation 1820 may be performed by the one or more WWAN transceivers 310, the one or more processors 332, memory 340, and/or relay component 342, any or all of which may be considered means for performing this operation.

At 1830, the relay UE receives downlink data for the remote UE from the serving base station, as described above with reference to, for example, operations 1420 and 1520. In an aspect, operation 1830 may be performed by the one or more WWAN transceivers 310, the one or more processors 332, memory 340, and/or relay component 342, any or all of which may be considered means for performing this operation.

At 1840, the relay UE transmits SCI instructing the remote UE to switch from a first sidelink BWP of the sidelink to a second sidelink BWP of the sidelink, as described above with reference to, for example, operations 1430 and 1540. In an aspect, operation 1840 may be performed by the one or more WWAN transceivers 310, the one or more processors 332, memory 340, and/or relay component 342, any or all of which may be considered means for performing this operation.

At 1850, the relay UE forwards the downlink data to the remote UE over the second sidelink BWP of the sidelink, as described above with reference to, for example, operations 1440 and 1550. In an aspect, operation 1850 may be performed by the one or more WWAN transceivers 310, the one or more processors 332, memory 340, and/or relay component 342, any or all of which may be considered means for performing this operation.

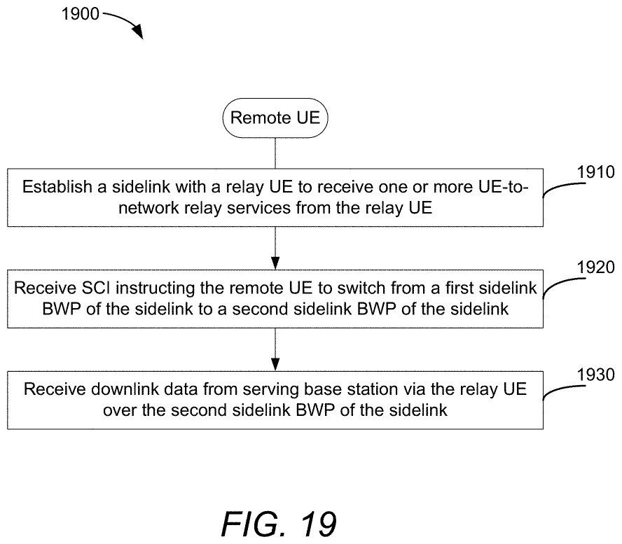

FIG. 19 illustrates an example method 1900 of wireless communication, according to aspects of the disclosure. In an aspect, the method 1900 may be performed by a remote UE (e.g., any of the UEs described herein).

At 1910, the remote UE establishes a sidelink with a relay UE to receive one or more UE-to-network relay services from the relay UE, as described above with reference to FIGS. 9A and 9B. In an aspect, operation 1910 may be performed by the one or more WWAN transceivers 310, the one or more processors 332, memory 340, and/or relay component 342, any or all of which may be considered means for performing this operation.

At 1920, the remote UE receives SCI instructing the remote UE to switch from a first sidelink BWP of the sidelink to a second sidelink BWP of the sidelink, as described above with reference to, for example, operations 1430 and 1540. In an aspect, operation 1920 may be performed by the one or more WWAN transceivers 310, the one or more processors 332, memory 340, and/or relay component 342, any or all of which may be considered means for performing this operation.

At 1930, the remote UE receives downlink data from a serving base station (e.g., any of the base stations described herein) via the relay UE over the second sidelink BWP of the sidelink, as described above with reference to, for example, operations 1440 and 1550. In an aspect, operation 1930 may be performed by the one or more WWAN transceivers 310, the one or more processors 332, memory 340, and/or relay component 342, any or all of which may be considered means for performing this operation.

As will be appreciated, a technical advantage of the methods 1600 to 1900 is enabling the remote and/or relay UEs to determine which BWP to use for paging.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a relay user equipment (UE), comprising: establishing a sidelink with a remote UE to provide one or more UE-to-network relay services to the remote UE; monitoring paging occasions (POs) in a first bandwidth part (BWP); receiving a first page from a serving base station during a PO in the first BWP; and forwarding the first page to the remote UE over the sidelink in an initial sidelink BWP for the sidelink.

Clause 2. The method of clause 1, further comprising: receiving, from the remote UE over the sidelink, PO information for the remote UE, wherein the PO information is included in a PC5 radio resource control (RRC) message.

Clause 3. The method of clause 2, wherein: the PO information identifies the PO in the first BWP, or the PO information indicates a paging cycle for the remote UE and an identifier of the remote UE.

Clause 4. The method of clause 3, wherein: the identifier of the remote UE is a hashed international mobile subscriber identity (IMSI) or an inactive radio network temporary identifier (I-RNTI), and the hash function is configured via a dedicated Uu radio resource control (RRC) message or a system information block (SIB), or is pre-configured.

Clause 5. The method of any of clauses 3 to 4, wherein the identifier of the remote UE is provided by a core access and mobility management function (AMF).

Clause 6. The method of any of clauses 1 to 5, wherein: the relay UE is in an RRC inactive state or an RRC idle state, the remote UE is in an RRC inactive state or an RRC idle state, the first BWP is an initial BWP for the serving base station, and the POs monitored in the initial BWP include all POs in the initial BWP for the relay UE and all POs in the initial BWP for the remote UE.

Clause 7. The method of any of clauses 1 to 6, wherein: the first page comprises a SIB update or an emergency notification, and the relay UE forwards the first page to the remote UE in a dedicated, broadcast, or groupcast PC5 message.

Clause 8. The method of any of clauses 1 to 5, wherein: the relay UE is in an RRC connected state, the remote UE is in an RRC inactive state or an RRC idle state, the first BWP is an active BWP for the relay UE, and the POs monitored in the active BWP include all POs in the active BWP for the relay UE and all POs in the active BWP for the remote UE.

Clause 9. The method of any of clauses 1 to 6 and 8, wherein: the first page comprises a dedicated page for the remote UE, the relay UE forwards the first page to the remote UE in a PC5 RRC message, the first page is associated with information indicating that the first page is directed to the remote UE, and the information indicating that the first page is directed to the remote UE is included in an RRC message from the serving base station.

Clause 10. The method of any of clauses 1 to 9, wherein: the relay UE only forwards SIB updates or emergency notifications to the remote UE, and the relay UE does not monitor the first BWP for dedicated pages for the remote UE.

Clause 11. The method of any of clauses 1 to 10, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 12. A method of wireless communication performed by a remote user equipment (UE), comprising: establishing a sidelink with a relay UE to receive one or more UE-to-network relay services from the relay UE; and receiving, from the relay UE over the sidelink in an initial sidelink BWP for the sidelink, a first page forwarded from a serving base station, wherein the first page was transmitted by the serving base station in a first bandwidth part (BWP).

Clause 13. The method of clause 12, further comprising: transmitting, to the relay UE over the sidelink, paging occasion (PO) information identifying POs during which the remote UE may be paged by the serving base station.

Clause 14. The method of clause 13, wherein the PO information is included in a PC5 radio resource control (RRC) message.

Clause 15. The method of any of clauses 13 to 14, wherein: the PO information identifies the POs in the first BWP, or the PO information indicates a paging cycle for the remote UE and an identifier of the remote UE.

Clause 16. The method of clause 15, wherein: the identifier of the remote UE is a hashed international mobile subscriber identity (IMSI) or an inactive radio network temporary identifier (I-RNTI), and the hash function is configured via a dedicated Uu radio resource control (RRC) message or a system information block (SIB), or is pre-configured.

Clause 17. The method of any of clauses 15 to 16, wherein the identifier of the remote UE is provided by a core access and mobility management function (AMF).

Clause 18. The method of any of clauses 12 to 17, wherein: the remote UE is in an RRC inactive state or an RRC idle state, the relay UE is in an RRC inactive state or an RRC idle state, and the first BWP is an initial BWP for the serving base station.

Clause 19. The method of any of clauses 12 to 18, wherein: the first page comprises a system information block (SIB) update or an emergency notification, and the remote UE receives the first page from the relay UE in a dedicated, broadcast, or groupcast PC5 message.

Clause 20. The method of any of clauses 12 to 17 and 19, wherein: the remote UE is in an RRC inactive state or an RRC idle state, the relay UE is in an RRC connected state, the first BWP is an active BWP for the relay UE, the remote UE does not monitor for pages from the serving base station, the first page comprises a dedicated page for the remote UE, and the remote UE receives the first page from the relay UE in a PC5 RRC message.

Clause 21. The method of any of clauses 12 to 17 and 19, wherein: the remote UE is in an RRC inactive state or an RRC idle state, the relay UE is in an RRC connected state, the first BWP is an active BWP for the relay UE, and the remote UE only monitors for dedicated pages from the serving base station in an initial BWP of the serving base station.

Clause 22. The method of any of clauses 12 to 21, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 23. A method of wireless communication performed by a relay user equipment (UE), comprising: establishing a sidelink with a remote UE to provide one or more UE-to-network relay services to the remote UE; receiving downlink control information (DCI) from a serving base station for a downlink grant for the remote UE; receiving downlink data for the remote UE from the serving base station; transmitting sidelink control information (SCI) instructing the remote UE to switch from a first sidelink bandwidth part (BWP) of the sidelink to a second sidelink BWP of the sidelink; and forwarding the downlink data to the remote UE over the second sidelink BWP of the sidelink.

Clause 24. The method of clause 23, wherein the DCI includes an identifier of the second sidelink BWP.

Clause 25. The method of any of clauses 23 to 24, further comprising: determining to use the second sidelink BWP to transmit the downlink data to the remote UE.

Clause 26. The method of any of clauses 23 to 25, wherein: the relay UE is in an RRC connected state, and the remote UE is in an RRC connected state.

Clause 27. A method of wireless communication performed by a remote user equipment (UE), comprising: establishing a sidelink with a relay UE to receive one or more UE-to-network relay services from the relay UE; receiving sidelink control information (SCI) instructing the remote UE to switch from a first sidelink bandwidth part (BWP) of the sidelink to a second sidelink BWP of the sidelink; and receiving downlink data from a serving base station via the relay UE over the second sidelink BWP of the sidelink.

Clause 28. The method of clause 27, wherein: the relay UE is in an RRC connected state, and the remote UE is in an RRC connected state.

Clause 29. The method of any of clauses 27 to 28, wherein: the downlink data comprises physical downlink shared channel (PDSCH), and the remote UE receives the downlink data over a physical sidelink shared channel (PSSCH) of the sidelink.

Clause 30. The method of any of clauses 27 to 29, wherein: the second sidelink BWP is indicated in downlink control information (DCI) from the serving base station, or the second sidelink BWP is selected by the relay UE.

Clause 31. An apparatus comprising a memory, at least one transceiver, and at least one processor communicatively coupled to the memory and the at least one transceiver, the memory, the at least one transceiver, and the at least one processor configured to perform a method according to any of clauses 1 to 30.

Clause 32. An apparatus comprising means for performing a method according to any of clauses 1 to 30.

Clause 33. A non-transitory computer-readable medium storing computer-executable instructions, the computer-executable comprising at least one instruction for causing a computer or processor to perform a method according to any of clauses 1 to 30.

Additional implementation examples are described in the following numbered clauses:

Clause 1. A method of wireless communication performed by a relay user equipment (UE), comprising: establishing a sidelink with a remote UE to provide one or more UE-to-network relay services to the remote UE; monitoring paging occasions (POs) in a first bandwidth part (BWP); receiving a first page from a serving base station during a PO in the first BWP; and forwarding the first page to the remote UE over the sidelink in an initial sidelink BWP for the sidelink.

Clause 2. The method of clause 1, further comprising: receiving, from the remote UE over the sidelink, PO information for the remote UE, wherein the PO information is included in a PCS radio resource control (RRC) message.

Clause 3. The method of clause 2, wherein: the PO information identifies the PO in the first BWP, or the PO information indicates a paging cycle for the remote UE and an identifier of the remote UE.

Clause 4. The method of clause 3, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 5. The method of any of clauses 3 to 4, wherein the identifier of the remote UE is provided by a core access and mobility management function (AMF).

Clause 6. The method of any of clauses 1 to 5, wherein: the relay UE is in an RRC inactive state or an RRC idle state, the remote UE is in an RRC inactive state or an RRC idle state, the first BWP is an initial BWP for the serving base station, and the POs monitored in the initial BWP include all POs in the initial BWP for the relay UE and all POs in the initial BWP for the remote UE.

Clause 7. The method of any of clauses 1 to 6, wherein: the first page comprises a SIB update or an emergency notification, and the relay UE forwards at least the SIB update or the emergency notification of the first page to the remote UE in a dedicated, broadcast, or groupcast PC5 RRC message.

Clause 8. The method of any of clauses 1 to 5 and 7, wherein: the relay UE is in an RRC connected state, the remote UE is in an RRC inactive state or an RRC idle state, the first BWP is an active BWP for the relay UE, and the POs monitored in the active BWP include all POs in the active BWP for the relay UE and all POs in the active BWP for the remote UE.

Clause 9. The method of any of clauses 1 to 8, wherein: the first page comprises a dedicated page for the remote UE, the relay UE forwards the first page to the remote UE in a PC5 RRC message, the first page is associated with information indicating that the first page is directed to the remote UE, and the information indicating that the first page is directed to the remote UE is included in an RRC message from the serving base station.

Clause 10. The method of any of clauses 1 to 9, wherein: the relay UE only forwards SIB updates or emergency notifications to the remote UE, and the relay UE does not monitor the first BWP for dedicated pages for the remote UE.

Clause 11. The method of any of clauses 1 to 10, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 12. A method of wireless communication performed by a remote user equipment (UE), comprising: establishing a sidelink with a relay UE to receive one or more UE-to-network relay services from the relay UE; and receiving, from the relay UE over the sidelink in an initial sidelink BWP for the sidelink, a first page forwarded from a serving base station, wherein the first page was transmitted by the serving base station in a first bandwidth part (BWP).

Clause 13. The method of clause 12, further comprising: transmitting, to the relay UE over the sidelink, paging occasion (PO) information identifying POs during which the remote UE may be paged by the serving base station.

Clause 14. The method of clause 13, wherein the PO information is included in a PC5 radio resource control (RRC) message.

Clause 15. The method of any of clauses 13 to 14, wherein: the PO information identifies the POs in the first BWP, or the PO information indicates a paging cycle for the remote UE and an identifier of the remote UE.

Clause 16. The method of clause 15, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 17. The method of any of clauses 15 to 16, wherein the identifier of the remote UE is provided by a core access and mobility management function (AMF).

Clause 18. The method of any of clauses 12 to 17, wherein: the remote UE is in an RRC inactive state or an RRC idle state, the relay UE is in an RRC inactive state or an RRC idle state, and the first BWP is an initial BWP for the serving base station.

Clause 19. The method of any of clauses 12 to 18, wherein: the first page comprises a system information block (SIB) update or an emergency notification, and the remote UE receives at least the SIB update or the emergency notification of the first page from the relay UE in a dedicated, broadcast, or groupcast PC5 RRC message.

Clause 20. The method of any of clauses 12 to 17 and 19, wherein: the remote UE is in an RRC inactive state or an RRC idle state, the relay UE is in an RRC connected state, the first BWP is an active BWP for the relay UE, the remote UE does not monitor for pages from the serving base station, the first page comprises a dedicated page for the remote UE, and the remote UE receives the first page from the relay UE in a PC5 RRC message.

Clause 21. The method of any of clauses 12 to 17 and 19, wherein: the remote UE is in an RRC inactive state or an RRC idle state, the relay UE is in an RRC connected state, the first BWP is an active BWP for the relay UE, and the remote UE only monitors for dedicated pages from the serving base station in an initial BWP of the serving base station.

Clause 22. The method of any of clauses 12 to 21, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 23. A method of wireless communication performed by a relay user equipment (UE), comprising: establishing a sidelink with a remote UE to provide one or more UE-to-network relay services to the remote UE; receiving downlink control information (DCI) from a serving base station for a downlink grant for the remote UE; receiving downlink data for the remote UE from the serving base station; transmitting sidelink control information (SCI) instructing the remote UE to switch from a first sidelink bandwidth part (BWP) of the sidelink to a second sidelink BWP of the sidelink; and forwarding the downlink data to the remote UE over the second sidelink BWP of the sidelink.

Clause 24. The method of clause 23, wherein the DCI includes an identifier of the second sidelink BWP.

Clause 25. The method of any of clauses 23 to 24, further comprising: determining to use the second sidelink BWP to transmit the downlink data to the remote UE.

Clause 26. The method of any of clauses 23 to 25, wherein: the relay UE is in an RRC connected state, and the remote UE is in an RRC connected state.

Clause 27. A method of wireless communication performed by a remote user equipment (UE), comprising: establishing a sidelink with a relay UE to receive one or more UE-to-network relay services from the relay UE; receiving sidelink control information (SCI) instructing the remote UE to switch from a first sidelink bandwidth part (BWP) of the sidelink to a second sidelink BWP of the sidelink; and receiving downlink data from a serving base station via the relay UE over the second sidelink BWP of the sidelink.

Clause 28. The method of clause 27, wherein: the relay UE is in an RRC connected state, and the remote UE is in an RRC connected state.

Clause 29. The method of any of clauses 27 to 28, wherein: the downlink data comprises physical downlink shared channel (PDSCH), and the remote UE receives the downlink data over a physical sidelink shared channel (PSSCH) of the sidelink.

Clause 30. The method of any of clauses 27 to 29, wherein: the second sidelink BWP is indicated in downlink control information (DCI) from the serving base station, or the second sidelink BWP is selected by the relay UE.

Clause 31. A relay user equipment (UE), comprising: a memory; at least one transceiver; and at least one processor communicatively coupled to the memory and the at least one transceiver, the at least one processor configured to: establish a sidelink with a remote UE to provide one or more UE-to-network relay services to the remote UE; monitor paging occasions (POs) in a first bandwidth part (BWP); receive, via the at least one transceiver, a first page from a serving base station during a PO in the first BWP; and forward the first page to the remote UE over the sidelink in an initial sidelink BWP for the sidelink.

Clause 32. The relay UE of clause 31, wherein the at least one processor is further configured to: receive, via the at least one transceiver, from the remote UE over the sidelink, PO information for the remote UE, wherein the PO information is included in a PC5 radio resource control (RRC) message.

Clause 33. The relay UE of clause 32, wherein: the PO information identifies the PO in the first BWP, or the PO information indicates a paging cycle for the remote UE and an identifier of the remote UE.

Clause 34. The relay UE of clause 33, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 35. The relay UE of any of clauses 33 to 34, wherein the identifier of the remote UE is provided by a core access and mobility management function (AMF).

Clause 36. The UE of any of clauses 31 to 35, wherein: the relay UE is in an RRC inactive state or an RRC idle state, the remote UE is in an RRC inactive state or an RRC idle state, the first BWP is an initial BWP for the serving base station, and the POs monitored in the initial BWP include all POs in the initial BWP for the relay UE and all POs in the initial BWP for the remote UE.

Clause 37. The relay UE of any of clauses 31 to 36, wherein: the first page comprises a SIB update or an emergency notification, and the relay UE forwards at least the SIB update or the emergency notification of the first page to the remote UE in a dedicated, broadcast, or groupcast PC5 RRC message.

Clause 38. The relay UE of any of clauses 31 to 35 and 37, wherein: the relay UE is in an RRC connected state, the remote UE is in an RRC inactive state or an RRC idle state, the first BWP is an active BWP for the relay UE, and the POs monitored in the active BWP include all POs in the active BWP for the relay UE and all POs in the active BWP for the remote UE.

Clause 39. The relay UE of any of clauses 31 to 38, wherein: the first page comprises a dedicated page for the remote UE, the relay UE forwards the first page to the remote UE in a PC5 RRC message, the first page is associated with information indicating that the first page is directed to the remote UE, and the information indicating that the first page is directed to the remote UE is included in an RRC message from the serving base station.

Clause 40. The relay UE of any of clauses 31 to 39, wherein: the relay UE only forwards SIB updates or emergency notifications to the remote UE, and the relay UE does not monitor the first BWP for dedicated pages for the remote UE.

Clause 41. The relay UE of any of clauses 31 to 40, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 42. A remote user equipment (UE), comprising: a memory; at least one transceiver; and at least one processor communicatively coupled to the memory and the at least one transceiver, the at least one processor configured to: establish a sidelink with a relay UE to receive one or more UE-to-network relay services from the relay UE; and receive, via the at least one transceiver, from the relay UE over the sidelink in an initial sidelink BWP for the sidelink, a first page forwarded from a serving base station, wherein the first page was transmitted by the serving base station in a first bandwidth part (BWP).

Clause 43. The remote UE of clause 42, wherein the at least one processor is further configured to: transmit, via the at least one transceiver, to the relay UE over the sidelink, paging occasion (PO) information identifying POs during which the remote UE may be paged by the serving base station.

Clause 44. The remote UE of clause 43, wherein the PO information is included in a PC5 radio resource control (RRC) message.

Clause 45. The remote UE of any of clauses 43 to 44, wherein: the PO information identifies the POs in the first BWP, or the PO information indicates a paging cycle for the remote UE and an identifier of the remote UE.

Clause 46. The remote UE of clause 45, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 47. The remote UE of any of clauses 45 to 46, wherein the identifier of the remote UE is provided by a core access and mobility management function (AMF).

Clause 48. The remote UE of any of clauses 42 to 47, wherein: the remote UE is in an RRC inactive state or an RRC idle state, the relay UE is in an RRC inactive state or an RRC idle state, and the first BWP is an initial BWP for the serving base station.

Clause 49. The remote UE of any of clauses 42 to 48, wherein: the first page comprises a system information block (SIB) update or an emergency notification, and the remote UE receives at least the SIB update or the emergency notification of the first page from the relay UE in a dedicated, broadcast, or groupcast PC5 RRC message.

Clause 50. The remote UE of any of clauses 42 to 47 and 49, wherein: the remote UE is in an RRC inactive state or an RRC idle state, the relay UE is in an RRC connected state, the first BWP is an active BWP for the relay UE, the remote UE does not monitor for pages from the serving base station, the first page comprises a dedicated page for the remote UE, and the remote UE receives the first page from the relay UE in a PC5 RRC message.

Clause 51. The remote UE of any of clauses 42 to 47 and 49, wherein: the remote UE is in an RRC inactive state or an RRC idle state, the relay UE is in an RRC connected state, the first BWP is an active BWP for the relay UE, and the remote UE only monitors for dedicated pages from the serving base station in an initial BWP of the serving base station.

Clause 52. The remote UE of any of clauses 42 to 51, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 53. A relay user equipment (UE), comprising: a memory; at least one transceiver; and at least one processor communicatively coupled to the memory and the at least one transceiver, the at least one processor configured to: establish a sidelink with a remote UE to provide one or more UE-to-network relay services to the remote UE; receive, via the at least one transceiver, downlink control information (DCI) from a serving base station for a downlink grant for the remote UE; receive, via the at least one transceiver, downlink data for the remote UE from the serving base station; transmit, via the at least one transceiver, sidelink control information (SCI) instructing the remote UE to switch from a first sidelink bandwidth part (BWP) of the sidelink to a second sidelink BWP of the sidelink; and forward the downlink data to the remote UE over the second sidelink BWP of the sidelink.

Clause 54. The relay UE of clause 53, wherein the DCI includes an identifier of the second sidelink BWP.

Clause 55. The relay UE of any of clauses 53 to 54, wherein the at least one processor is further configured to: determine to use the second sidelink BWP to transmit the downlink data to the remote UE.

Clause 56. The relay UE of any of clauses 53 to 55, wherein: the relay UE is in an RRC connected state, and the remote UE is in an RRC connected state.

Clause 57. A remote user equipment (UE), comprising: a memory; at least one transceiver; and at least one processor communicatively coupled to the memory and the at least one transceiver, the at least one processor configured to: establish a sidelink with a relay UE to receive one or more UE-to-network relay services from the relay UE; receive, via the at least one transceiver, sidelink control information (SCI) instructing the remote UE to switch from a first sidelink bandwidth part (BWP) of the sidelink to a second sidelink BWP of the sidelink; and receive, via the at least one transceiver, downlink data from a serving base station via the relay UE over the second sidelink BWP of the sidelink.

Clause 58. The remote UE of clause 57, wherein: the relay UE is in an RRC connected state, and the remote UE is in an RRC connected state.

Clause 59. The remote UE of any of clauses 57 to 58, wherein: the downlink data comprises physical downlink shared channel (PDSCH), and the remote UE receives the downlink data over a physical sidelink shared channel (PSSCH) of the sidelink.

Clause 60. The remote UE of any of clauses 57 to 59, wherein: the second sidelink BWP is indicated in downlink control information (DCI) from the serving base station, or the second sidelink BWP is selected by the relay UE.

Clause 61. A relay user equipment (UE), comprising: means for establishing a sidelink with a remote UE to provide one or more UE-to-network relay services to the remote UE; means for monitoring paging occasions (POs) in a first bandwidth part (BWP); means for receiving a first page from a serving base station during a PO in the first BWP; and means for forwarding the first page to the remote UE over the sidelink in an initial sidelink BWP for the sidelink.

Clause 62. The relay UE of clause 61, further comprising: means for receiving, from the remote UE over the sidelink, PO information for the remote UE, wherein the PO information is included in a PC5 radio resource control (RRC) message.

Clause 63. The relay UE of clause 62, wherein: the PO information identifies the PO in the first BWP, or the PO information indicates a paging cycle for the remote UE and an identifier of the remote UE.

Clause 64. The relay UE of clause 63, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 65. The relay UE of any of clauses 63 to 64, wherein the identifier of the remote UE is provided by a core access and mobility management function (AMF).

Clause 66. The relay UE of any of clauses 61 to 65, wherein: the relay UE is in an RRC inactive state or an RRC idle state, the remote UE is in an RRC inactive state or an RRC idle state, the first BWP is an initial BWP for the serving base station, and the POs monitored in the initial BWP include all POs in the initial BWP for the relay UE and all POs in the initial BWP for the remote UE.

Clause 67. The relay UE of any of clauses 61 to 66, wherein: the first page comprises a SIB update or an emergency notification, and the relay UE forwards at least the SIB update or the emergency notification of the first page to the remote UE in a dedicated, broadcast, or groupcast PC5 RRC message.

Clause 68. The relay UE of any of clauses 61 to 65 and 67, wherein: the relay UE is in an RRC connected state, the remote UE is in an RRC inactive state or an RRC idle state, the first BWP is an active BWP for the relay UE, and the POs monitored in the active BWP include all POs in the active BWP for the relay UE and all POs in the active BWP for the remote UE.

Clause 69. The relay UE of any of clauses 61 to 68, wherein: the first page comprises a dedicated page for the remote UE, the relay UE forwards the first page to the remote UE in a PC5 RRC message, the first page is associated with information indicating that the first page is directed to the remote UE, and the information indicating that the first page is directed to the remote UE is included in an RRC message from the serving base station.

Clause 70. The relay UE of any of clauses 61 to 69, wherein: the relay UE only forwards SIB updates or emergency notifications to the remote UE, and the relay UE does not monitor the first BWP for dedicated pages for the remote UE.

Clause 71. The relay UE of any of clauses 61 to 70, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 72. A remote user equipment (UE), comprising: means for establishing a sidelink with a relay UE to receive one or more UE-to-network relay services from the relay UE; and means for receiving, from the relay UE over the sidelink in an initial sidelink BWP for the sidelink, a first page forwarded from a serving base station, wherein the first page was transmitted by the serving base station in a first bandwidth part (BWP).

Clause 73. The remote UE of clause 72, further comprising: means for transmitting, to the relay UE over the sidelink, paging occasion (PO) information identifying POs during which the remote UE may be paged by the serving base station.

Clause 74. The remote UE of clause 73, wherein the PO information is included in a PC5 radio resource control (RRC) message.

Clause 75. The remote UE of any of clauses 73 to 74, wherein: the PO information identifies the POs in the first BWP, or the PO information indicates a paging cycle for the remote UE and an identifier of the remote UE.

Clause 76. The remote UE of clause 75, wherein: the identifier of the remote UE is a hashed international mobile subscriber identity (IMSI) or an inactive radio network temporary identifier (I-RNTI), and a hash function used for the IMSI or the I-RNTI is configured via a dedicated Uu radio resource control (RRC) message or a system information block (SIB), or is pre-configured.

Clause 77. The remote UE of any of clauses 75 to 76, wherein the identifier of the remote UE is provided by a core access and mobility management function (AMF).

Clause 78. The remote UE of any of clauses 72 to 77, wherein: the remote UE is in an RRC inactive state or an RRC idle state, the relay UE is in an RRC inactive state or an RRC idle state, and the first BWP is an initial BWP for the serving base station.

Clause 79. The remote UE of any of clauses 72 to 78, wherein: the first page comprises a system information block (SIB) update or an emergency notification, and the remote UE receives at least the SIB update or the emergency notification of the first page from the relay UE in a dedicated, broadcast, or groupcast PC5 RRC message.

Clause 80. The remote UE of any of clauses 72 to 77 and 79, wherein: the remote UE is in an RRC inactive state or an RRC idle state, the relay UE is in an RRC connected state, the first BWP is an active BWP for the relay UE, the remote UE does not monitor for pages from the serving base station, the first page comprises a dedicated page for the remote UE, and the remote UE receives the first page from the relay UE in a PC5 RRC message.

Clause 81. The remote UE of any of clauses 72 to 77 and 79, wherein: the remote UE is in an RRC inactive state or an RRC idle state, the relay UE is in an RRC connected state, the first BWP is an active BWP for the relay UE, and the remote UE only monitors for dedicated pages from the serving base station in an initial BWP of the serving base station.

Clause 82. The remote UE of any of clauses 72 to 81, wherein: the relay UE and the remote UE are configured with a plurality of sidelink BWPs for the sidelink, and the initial sidelink BWP is one of the plurality of sidelink BWPs in which the relay UE and the remote UE completed relay selection.

Clause 83. A relay user equipment (UE), comprising: means for establishing a sidelink with a remote UE to provide one or more UE-to-network relay services to the remote UE; means for receiving downlink control information (DCI) from a serving base station for a downlink grant for the remote UE; means for receiving downlink data for the remote UE from the serving base station; means for transmitting sidelink control information (SCI) instructing the remote UE to switch from a first sidelink bandwidth part (BWP) of the sidelink to a second sidelink BWP of the sidelink; and means for forwarding the downlink data to the remote UE over the second sidelink BWP of the sidelink.

Clause 84. The relay UE of clause 83, wherein the DCI includes an identifier of the second sidelink BWP.

Clause 85. The relay UE of any of clauses 83 to 84, further comprising: means for determining to use the second sidelink BWP to transmit the downlink data to the remote UE.

Clause 86. The relay UE of any of clauses 83 to 85, wherein: the relay UE is in an RRC connected state, and the remote UE is in an RRC connected state.

Clause 87. A remote user equipment (UE), comprising: means for establishing a sidelink with a relay UE to receive one or more UE-to-network relay services from the relay UE; means for receiving sidelink control information (SCI) instructing the remote UE to switch from a first sidelink bandwidth part (BWP) of the sidelink to a second sidelink BWP of the sidelink; and means for receiving downlink data from a serving base station via the relay UE over the second sidelink BWP of the sidelink.

Clause 88. The remote UE of clause 87, wherein: the relay UE is in an RRC connected state, and the remote UE is in an RRC connected state.

Clause 89. The remote UE of any of clauses 87 to 88, wherein: the downlink data comprises physical downlink shared channel (PDSCH), and the remote UE receives the downlink data over a physical sidelink shared channel (PSSCH) of the sidelink.

Clause 90. The remote UE of any of clauses 87 to 89, wherein: the second sidelink BWP is indicated in downlink control information (DCI) from the serving base station, or the second sidelink BWP is selected by the relay UE.

Clause 91. A non-transitory computer-readable medium storing computer-executable instructions, the computer-executable comprising at least one instruction for causing a computer or processor to perform a method according to any of clauses 1 to 30.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a relay user equipment (UE), comprising:
establishing a sidelink with a remote UE to provide one or more UE-to-network relay services to the remote UE;
monitoring paging occasions (POs) in a first bandwidth part (BWP);
receiving a first page from a serving base station during a PO in the first BWP; and
forwarding the first page to the remote UE over the sidelink in an initial sidelink BWP for the sidelink.

2. The method of claim 1, further comprising:
receiving, from the remote UE over the sidelink, PO information for the remote UE, wherein the PO information is included in a PC5 radio resource control (RRC) message.

3. The method of claim 2, wherein:
the PO information identifies the PO in the first BWP, or
the PO information indicates a paging cycle for the remote UE and an identifier of the remote UE.

4. The method of claim 3, wherein:
the identifier of the remote UE is a hashed international mobile subscriber identity (IMSI) or an inactive radio network temporary identifier (I-RNTI), and
a hash function used for the IMSI or the I-RNTI is configured via a dedicated Uu radio resource control (RRC) message or a system information block (SIB), or is pre-configured.

5. The method of claim 3, wherein the identifier of the remote UE is provided by a core access and mobility management function (AMF).

6. The method of claim 1, wherein:
the relay UE is in an RRC inactive state or an RRC idle state,
the remote UE is in an RRC inactive state or an RRC idle state,
the first BWP is an initial BWP for the serving base station, and
the POs monitored in the initial BWP include all POs in the initial BWP for the relay UE and all POs in the initial BWP for the remote UE.

7. The method of claim 1, wherein:
the first page comprises a SIB update or an emergency notification, and
the relay UE forwards at least the SIB update or the emergency notification of the first page to the remote UE in a dedicated, broadcast, or groupcast PC5 RRC message.

8. The method of claim 1, wherein:
the relay UE is in an RRC connected state,
the remote UE is in an RRC inactive state or an RRC idle state,
the first BWP is an active BWP for the relay UE, and
the POs monitored in the active BWP include all POs in the active BWP for the relay UE and all POs in the active BWP for the remote UE.

9. The method of claim 1, wherein:
the first page comprises a dedicated page for the remote UE,
the relay UE forwards the first page to the remote UE in a PC5 RRC message,
the first page is associated with information indicating that the first page is directed to the remote UE, and
the information indicating that the first page is directed to the remote UE is included in an RRC message from the serving base station.

10. The method of claim 1, wherein:
the relay UE only forwards SIB updates or emergency notifications to the remote UE, and
the relay UE does not monitor the first BWP for dedicated pages for the remote UE.

11. The method of claim 1, wherein:
the relay UE and the remote UE are configured with a plurality of sidelink BWPs for the sidelink, and
the initial sidelink BWP is one of the plurality of sidelink BWPs in which the relay UE and the remote UE completed relay selection.

12. A method of wireless communication performed by a remote user equipment (UE), comprising:
establishing a sidelink with a relay UE to receive one or more UE-to-network relay services from the relay UE; and
receiving, from the relay UE over the sidelink in an initial sidelink BWP for the sidelink, a first page forwarded from a serving base station, wherein the first page was transmitted by the serving base station in a first bandwidth part (BWP).

13. The method of claim 12, further comprising:
transmitting, to the relay UE over the sidelink, paging occasion (PO) information identifying POs during which the remote UE may be paged by the serving base station.

14. The method of claim 13, wherein the PO information is included in a PC5 radio resource control (RRC) message.

15. The method of claim 13, wherein:
the PO information identifies the POs in the first BWP, or
the PO information indicates a paging cycle for the remote UE and an identifier of the remote UE.

16. The method of claim 15, wherein:
the identifier of the remote UE is a hashed international mobile subscriber identity (IMSI) or an inactive radio network temporary identifier (I-RNTI), and
a hash function used for the IMSI or the I-RNTI is configured via a dedicated Uu radio resource control (RRC) message or a system information block (SIB), or is pre-configured.

17. The method of claim 15, wherein the identifier of the remote UE is provided by a core access and mobility management function (AMF).

18. The method of claim 12, wherein:
the remote UE is in an RRC inactive state or an RRC idle state,
the relay UE is in an RRC inactive state or an RRC idle state, and
the first BWP is an initial BWP for the serving base station.

19. The method of claim 12, wherein:
the first page comprises a system information block (SIB) update or an emergency notification, and
the remote UE receives at least the SIB update or the emergency notification of the first page from the relay UE in a dedicated, broadcast, or groupcast PC5 RRC message.

20. The method of claim 12, wherein:
the remote UE is in an RRC inactive state or an RRC idle state,
the relay UE is in an RRC connected state,
the first BWP is an active BWP for the relay UE,
the remote UE does not monitor for pages from the serving base station,
the first page comprises a dedicated page for the remote UE, and the remote UE receives the first page from the relay UE in a PC5 RRC message.

21. The method of claim 12, wherein:
the remote UE is in an RRC inactive state or an RRC idle state,
the relay UE is in an RRC connected state,
the first BWP is an active BWP for the relay UE, and
the remote UE only monitors for dedicated pages from the serving base station in an initial BWP of the serving base station.

22. The method of claim 12, wherein:
the relay UE and the remote UE are configured with a plurality of sidelink BWPs for the sidelink, and
the initial sidelink BWP is one of the plurality of sidelink BWPs in which the relay UE and the remote UE completed relay selection.

23. A method of wireless communication performed by a relay user equipment (UE), comprising:
establishing a sidelink with a remote UE to provide one or more UE-to-network relay services to the remote UE;
receiving downlink control information (DCI) from a serving base station for a downlink grant for the remote UE;
receiving downlink data for the remote UE from the serving base station;
transmitting sidelink control information (SCI) instructing the remote UE to switch from a first sidelink bandwidth part (BWP) of the sidelink to a second sidelink BWP of the sidelink; and
forwarding the downlink data to the remote UE over the second sidelink BWP of the sidelink.

24. The method of claim 23, wherein the DCI includes an identifier of the second sidelink BWP.

25. The method of claim 23, further comprising:
determining to use the second sidelink BWP to transmit the downlink data to the remote UE.

26. The method of claim 23, wherein:
the relay UE is in an RRC connected state, and
the remote UE is in an RRC connected state.

27. A method of wireless communication performed by a remote user equipment (UE), comprising:
establishing a sidelink with a relay UE to receive one or more UE-to-network relay services from the relay UE;
receiving sidelink control information (SCI) instructing the remote UE to switch from a first sidelink bandwidth part (BWP) of the sidelink to a second sidelink BWP of the sidelink; and
receiving downlink data from a serving base station via the relay UE over the second sidelink BWP of the sidelink.

28. The method of claim 27, wherein:
the relay UE is in an RRC connected state, and
the remote UE is in an RRC connected state.

29. The method of claim 27, wherein:
the downlink data comprises physical downlink shared channel (PDSCH), and
the remote UE receives the downlink data over a physical sidelink shared channel (PSSCH) of the sidelink.

30. The method of claim 27, wherein:
the second sidelink BWP is indicated in downlink control information (DCI) from the serving base station, or
the second sidelink BWP is selected by the relay UE.
